(19) United States
(12) Patent Application Publication
(10) Pub. No.: US 2023/0140745 A1
(43) Pub. Date: May 4, 2023

(54) HANDLING OF CONDITIONAL RECONFIGURATION DELAY

(71) Applicant: Telefonaktiebolaget LM Ericsson (publ), Stockholm (SE)

(72) Inventors: Icaro Leonardo DA SILVA, Solna (SE); Lars FALK, Malmö (SE); Roman ZHOHOV, Linköping (SE)

(21) Appl. No.: 17/915,552

(22) PCT Filed: Apr. 9, 2021
(86) PCT No.: PCT/IB2021/052975

§ 371 Date: Sep. 29, 2022

Related U.S. Application Data
(60) Provisional application No. 63/007,723, filed on Apr. 9, 2020.

(51) Int. Cl. H04W 36/00

(52) U.S. Cl. CPC H04W 36/0016; H04W 36/00837

(57) ABSTRACT

A first network node in a communication network can communicate with a second network node to configure a conditional handover (“CHO”) for a communication device. The first network node can, responsive to communicating with the second network node to configure the CHO, determine a conditional reconfiguration delay.

### TECHNICAL FIELD

The present disclosure relates generally to communications, and more particularly to communication methods and related devices and nodes supporting wireless communications.

### BACKGROUND

One problem related to robustness at handover in long term evolution (“LTE”) and new radio (“NR”) is that the handover (“HO”) Command (e.g., RRCConnectionReconfiguration with mobilityControlInfo and RRCReconfiguration with a reconfigurationWithSync field) may be sent when the radio conditions for the user equipment (“UE”) (e.g., a communication device, wireless device, or terminal device) are already poor. As a result, the HO Command may not reach the UE in time if the message is segmented or there are retransmissions.

### SUMMARY

According to some embodiments, a method of operating a first network node in a communication network is provided. The method includes communicating with a second network node to configure a conditional handover (“CHO”) for a communication device. The method further includes, responsive to communicating with the second network node to configure the CHO, determining a conditional reconfiguration delay.

According to other embodiments, a method of operating a first network node in a communication network is provided. The method includes communicating a message with a second network node during configuration of a CHO for a communication device, the message comprising information associated with a conditional reconfiguration delay. The method further includes, responsive to communicating the message, determining a timer value associated with the CHO.

According to other embodiments, a method of operating a communication device in a communication network is provided. The method includes receiving from a network node a message comprising a CHO configuration and a timer value. The method further includes responsive to receiving the CHO configuration, starting a timer. The method further includes responsive to starting the timer, logging information associated with the amount of time elapsed since starting the timer.

Additional embodiments herein describe systems, devices, computer programs, and computer program products for performing the operations in the above method embodiments.

Various embodiments describe determining and handling conditional reconfiguration delays to improve resource reservation during a conditional handover.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a signal flow diagram illustrating an example of a conditional handover execution.

FIGS. 2-3 are tables illustrating examples of conditional handover information.

FIG. 4 is computer code illustrating an example of a conditionalReconfiguration field of a ConditionalReconfiguration information element.

FIG. 5 is computer code illustrating an example of the ConditionalReconfiguration information element.

FIG. 6 is computer code illustrating an example of a CondConfigToAddModList information element.

FIG. 7 is a table illustrating an example of CondConfigToAddMod field descriptions.

FIG. 8 is a signal flow diagram illustrating an example of a CHO preparation phase.

FIG. 9 is a signal flow diagram illustrating an example of initiating CHO execution.

FIG. 10 is a signal flow diagram illustrating an example of a source network node determining a CHO delay in accordance with some embodiments.

FIG. 11 is a signal flow diagram illustrating an example of using a CHO delay in accordance with some embodiments.

FIG. 12 is a signal flow diagram illustrating an example of determining a CHO delay at a target network node where CHO is executed in accordance with some embodiments.

FIG. 13 is a signal flow diagram illustrating an example of determining a CHO delay at a target network node where CHO is not executed in accordance with some embodiments.

FIG. 14 is computer code illustrating an example of a ConditionalReconfiguration information element in accordance with some embodiments.

FIG. 15 is a table illustrating an example of ConditionalReconfiguration field descriptions in accordance with some embodiments.

FIG. 16 is computer code illustrating an example of a CondConfigId information element in accordance with some embodiments.

FIG. 17 is a signal flow diagram illustrating an example of a CHO in accordance with some embodiments.

FIG. 18 is a block diagram illustrating an example of a communication device in accordance with some embodiments.

FIG. 19 is a block diagram illustrating an example of a radio access network (“RAN”) node in accordance with some embodiments.

FIG. 20 is a block diagram illustrating an example of a core network (“CN”) node in accordance with some embodiments.

FIGS. 21-27 are flow charts illustrating examples of a network node determining a conditional reconfiguration delay during a conditional handover over process in accordance with some embodiments.

FIGS. 28-29 are flow charts illustrating examples of a network node using a conditional reconfiguration delay during a conditional handover over process in accordance with some embodiments.

FIG. 30 is a flow chart illustrating an example of a communication device using conditional reconfiguration delays during a conditional handover over process in accordance with some embodiments.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

In LTE and NR, different solutions to increase mobility robustness have been discussed in the past. One solution discussed in NR is called “conditional handover” or “early handover command.” In order to avoid the undesired dependence on the serving radio link upon the time (and radio conditions) where the UE should execute the handover, the possibility to provide radio resource control (“RRC”) signaling for the handover to the UE earlier can be provided. To achieve this, the HO command can be associated with a condition. For example, the HO command can be based on radio conditions possibly similar to the ones associated to an A3 event, where a given neighbour becomes X db better than target. As soon as the condition is fulfilled, the UE executes the handover in accordance with the provided handover command.

Such a condition could, for example, be that the quality of the target cell or beam becomes X dB stronger than the serving cell. The threshold Y used in a preceding measurement reporting event can be chosen lower than the one in the handover execution condition. This allows the serving cell to prepare the handover upon reception of an early measurement report and to provide the RRCConnectionReconfiguration with mobilityControlInfo at a time when the radio link between the source cell and the UE is still stable. The execution of the handover is done at a later point in time (and threshold) which is considered optimal for the handover execution.

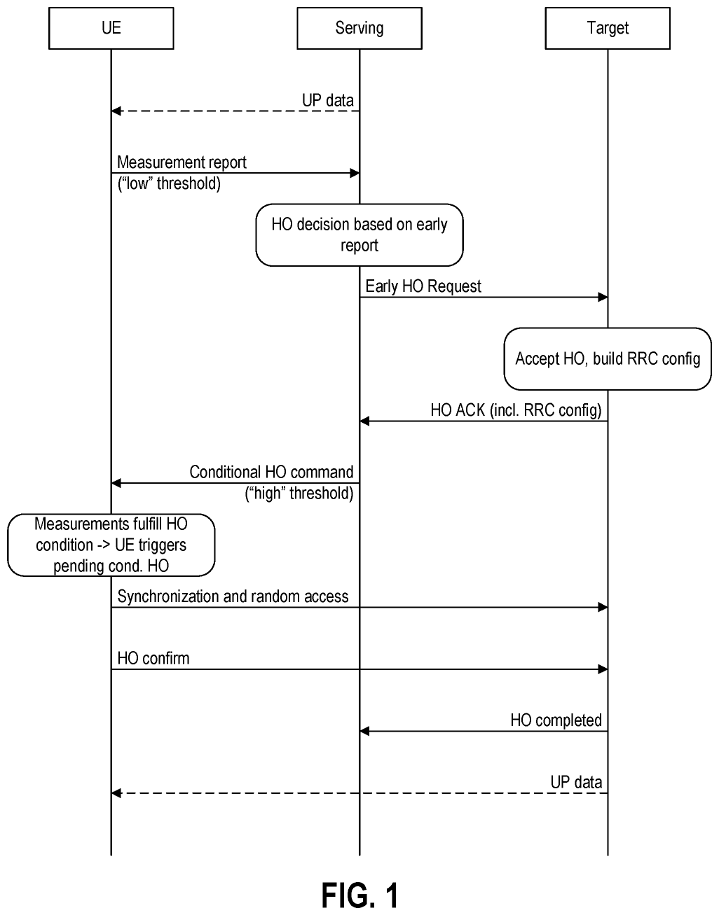

FIG. 1 depicts an example with just a serving and a target cell. In practice there may often be many cells or beams that the UE reported as possible candidates based on its preceding radio resource management (“RRM”) measurements. The network can have the freedom to issue conditional handover commands for several of those candidates. The RRCConnectionReconfiguration for each of those candidates may differ, for example, in terms of the HO execution condition (reference signal (“RS”) to measure and threshold to exceed) as well as in terms of the random access (“RA”) preamble to be sent when a condition is met. While the UE evaluates the condition, it should continue operating per its current RRC configuration (e.g., without applying the conditional HO command). When the UE determines that the condition is fulfilled, it disconnects from the serving cell and applies the conditional HO command and connects to the target cell.

A validity timer has been proposed to be introduced, in which a value is set by a target candidate node (e.g. gNodeB) for which the configuration would be valid. Deconfiguration of conditional HO, CHO, candidates may be performed by RRC signaling. Configuration of all CHO candidates may be released after any successful handover completion (e.g., by sending complete message to the target cell). For further study (“FFS”) if it might be possible to keep CHO candidates after the HO. However, one reasons not to define such a timer includes the uncertainty regarding how the network would set the timer value, despite a potential benefit of a target not having to cancel its CHO configuration with explicitly signaling over the Xn interface (in case of two NR gNodeBs) and over the air towards the UE with an RRC message.

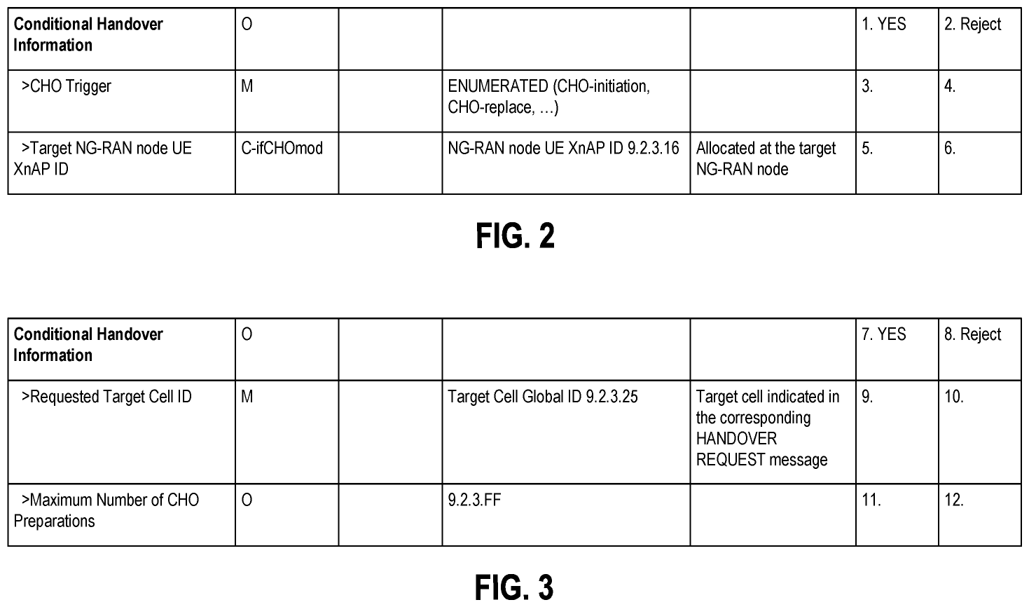

In some examples, a source node (e.g. a source gNodeB, gNB) requests a target candidate to configure CHO by transmitting a HANDOVER REQUEST message to each candidate target gNodeB (per candidate target cell ID). That message can include similar information compared to a legacy HANDOVER REQUEST (e.g. UE AS context, RRC configuration according to source, etc.) but it can also include some CHO specific information, to indicate to the target candidate node that this is a CHO instead of a legacy/immediate HO request, for example, the CHO Trigger called CHO-initiation, as illustrated in the table in FIG. 2.

If the admission control function at the target candidate accepts the request for CHO from a source gNodeB, it transmits in response a HANDOVER REQUEST ACKNOWLEDGE message, which is similar to legacy but includes some additional information regarding CHO, for example, as illustrated in the table in FIG. 3.

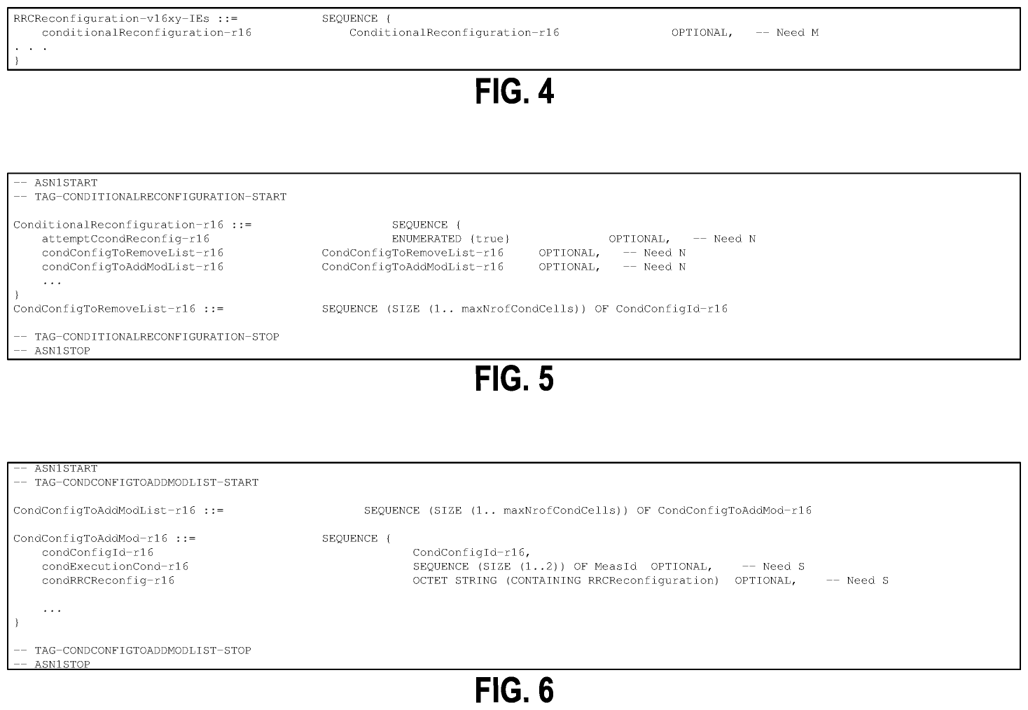

At that point the UE can be configured with CHO, for example, an RRCReconfiguration transmitted from source gNodeB to the UE including a CHO configuration (e.g. conditionalReconfiguration field of information element (“IE”) ConditionalReconfiguration) as illustrated in the computer code in FIG. 4.

The program code in FIG. 5 illustrates an example of the IE ConditionalReconfiguration, which is used to add, modify and release the configuration of conditional configuration.

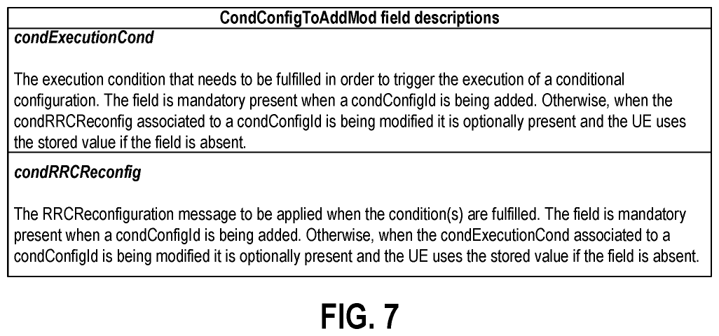

The program code in FIG. 6 illustrates an example of the IE CHO-ConfigToAddModList, which concerns a list of conditional configurations to add or modify with for each entry the cho-ConfigId and the associated condExecutionCond and condRRCReconfig. The table in FIG. 7 illustrates an example of CondConfigToAddMod field descriptions.

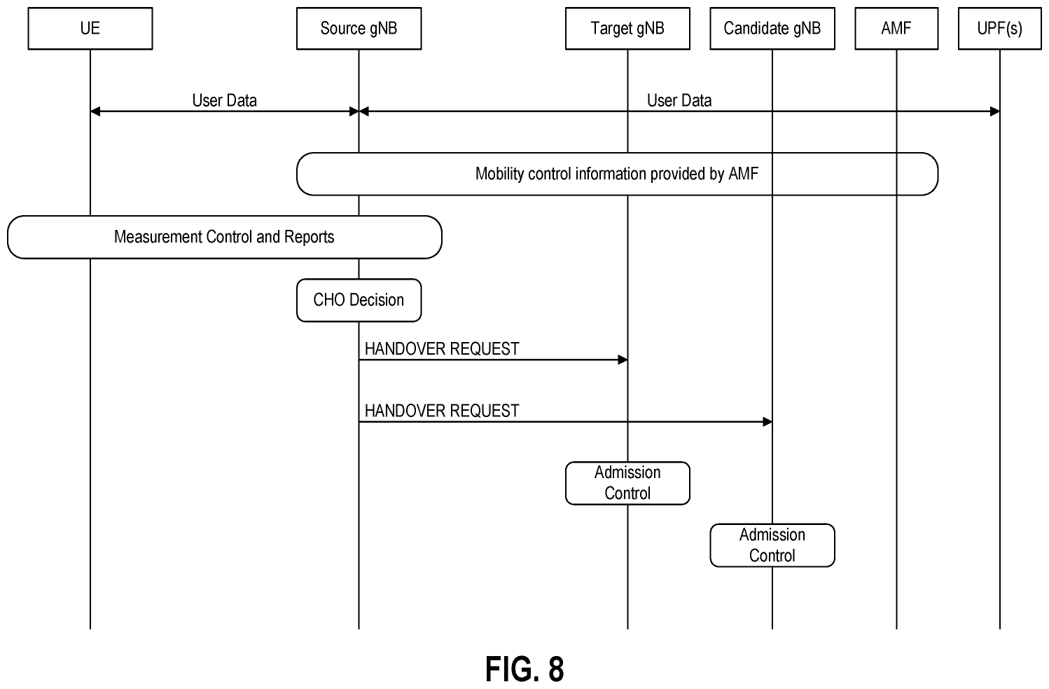

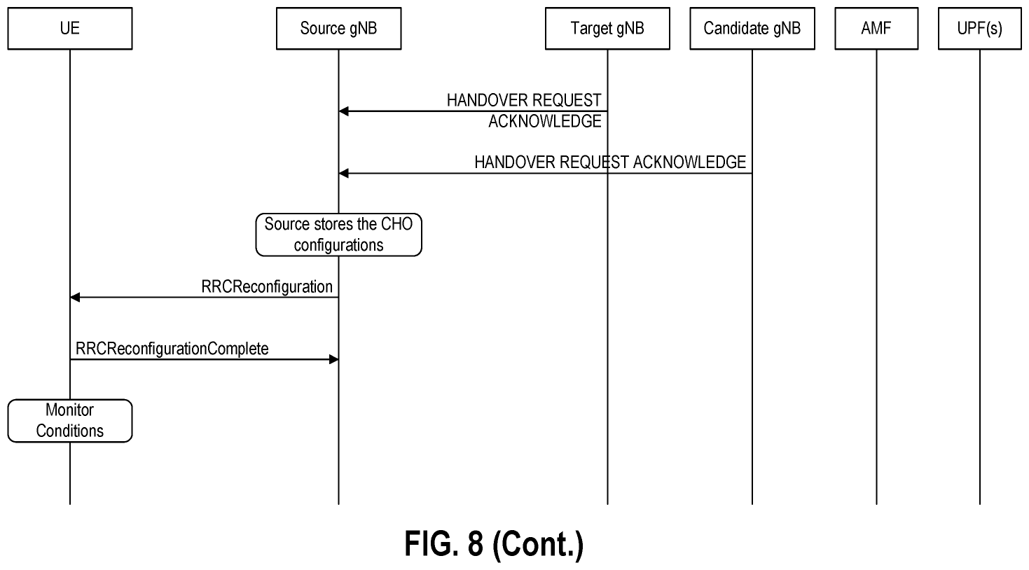

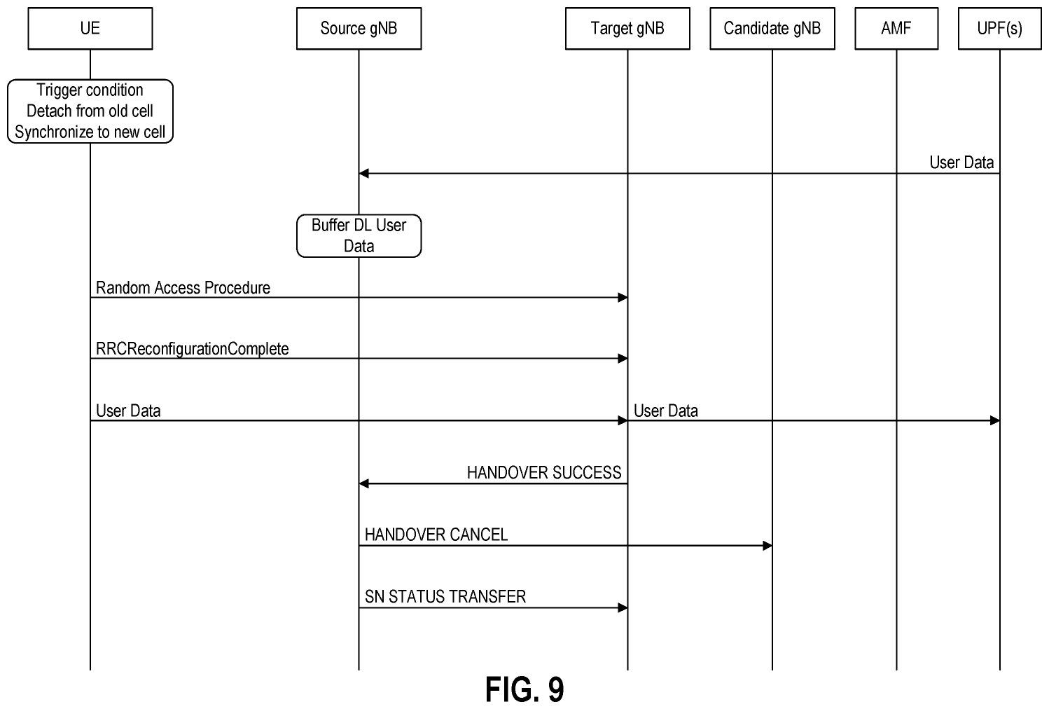

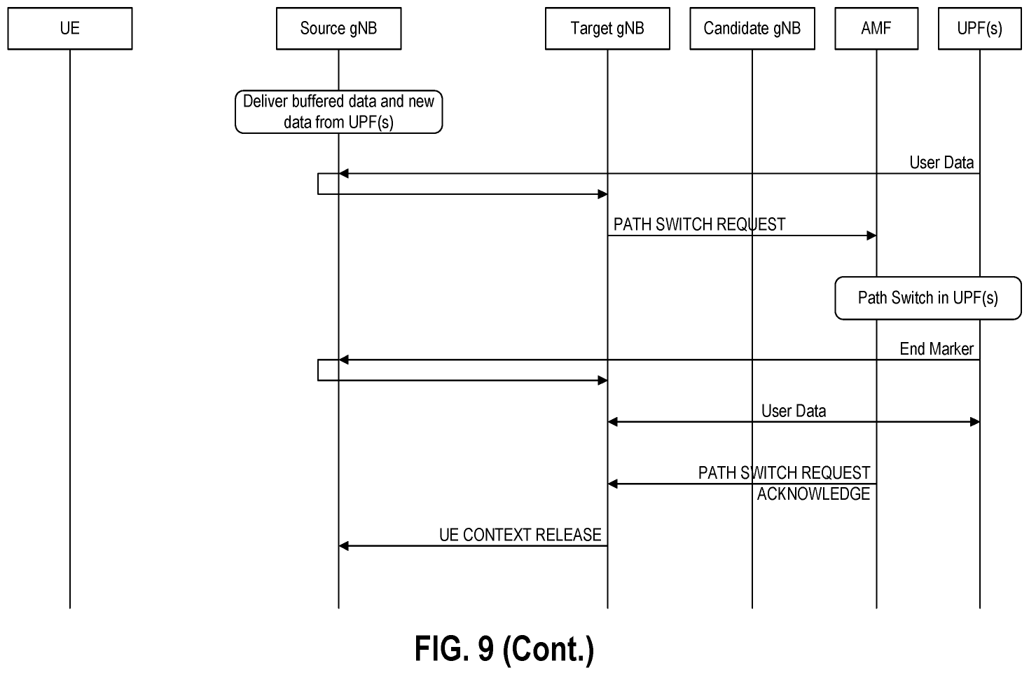

FIG. 8 illustrates an example of a preparation phase for a CHO and FIG. 9 illustrates an example of executing the CHO. When an execution condition is fulfilled at the UE, the UE selects a cell out of the cell(s) fulfilling the condition and initiates CHO execution (e.g., it applies the stored RRCReconfiguration associated to the selected target cell candidate, performs random access and transmits an RRCReconfigurationComplete to the target cell). Inefficiencies can arise due to multiple target cell candidates being configured, but only one of them may be executed. For example, some target candidate nodes would have reserved resources for a possibly incoming UE that would not come. In addition, the target node that receives that CHO request has no idea for how long it needs to reserve its resources for that possibly incoming UE. Even if the UE comes to a given target candidate, that target candidate node also does not know for how long the resources are to be allocated, which can create a challenge for its admission control function when deciding whether it should or not accept an incoming UE for CHO.

Various embodiments described herein provide information on the efficiency of resource reservation for CHO, which may be used as input to admission control algorithms. Furthermore, using statistics to determine timer values (e.g., to trigger a cancel procedure) a target node can avoid the use of a too long value or a too short value. A too long value can lead to a waste of resources with mistuned source nodes requesting CHO and a too short value can lead to unnecessary canceling procedures (which can degrade performance). In some embodiments, a UE can have validity timer values set to a statistically meaningful value prior to releasing resources.

In some embodiments, a first network node (e.g., a source gNB) for configuring CHO (conditional reconfiguration) determines delay values. The first network node determines to configure CHO to a wireless terminal (e.g., a UE or a communication device). The first network node transmits to a target node candidate a HANDOVER REQUEST message including an indication that this is for CHO (e.g. a Conditional Handover Information with CHO Trigger set to CHO-initiation). The first node network node receives a HANDOVER REQUEST ACKNOWLEDGE message from target node candidates. The first network node determines a first delay (e.g. CHO preparation delay) upon receiving the HANDOVER REQUEST ACKNOWLEDGE message, e.g. CHO preparation delay, where the preparation delay is the time between the transmission of the HANDOVER REQUEST with a CHO indication and the reception of the HANDOVER REQUEST ACKNOWLEDGE message. The first network node transmits an RRC Reconfiguration message to the UE including CHO configuration (e.g. conditional reconfiguration) for one or more target cell candidates associated to one or target node candidates.

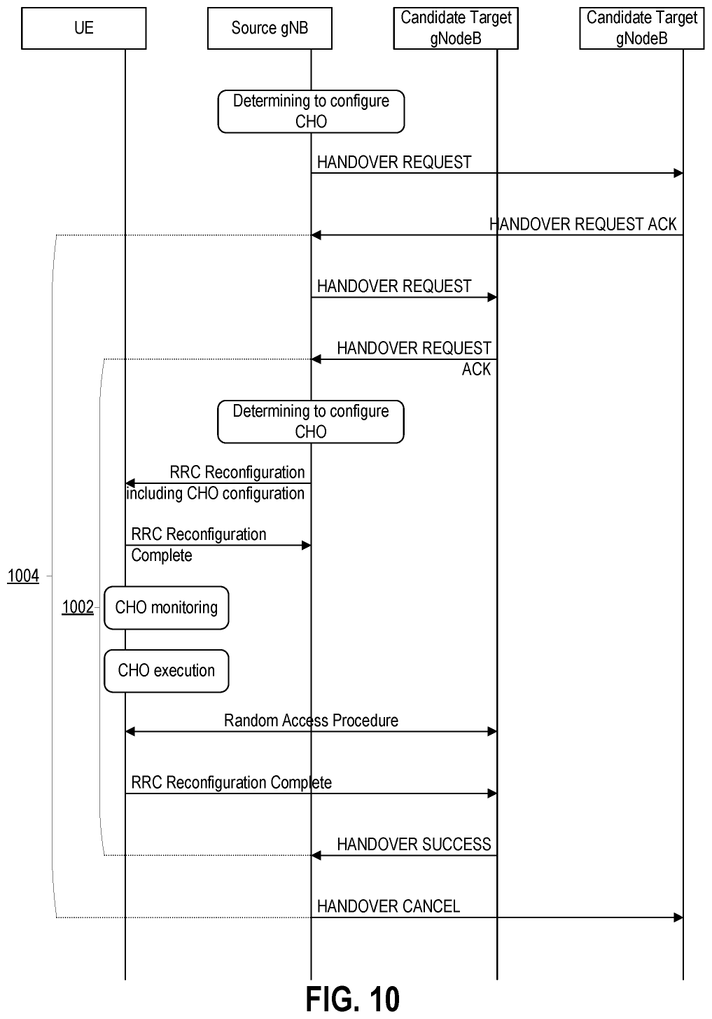

In additional or alternative embodiments, the first network node determines a second delay (e.g. CHO validity delay), which can be the time duration (or estimation of the time duration) for which CHO resources in a target candidate have been reserved before a CHO execution occurred. FIG. 10 illustrates an example of how the second delay may be determined. In some examples, the first network node may determine the second delay by determining an amount of time 1002 between the reception of the HANDOVER REQUEST ACKNOWLEDGE message from the target candidate and reception of the HANDOVER SUCCESS from the target candidate. In additional or alternative examples, the first network node may determine the second delay by determining an amount of time 1004 between the reception of the HANDOVER REQUEST ACKNOWLEDGE message from the target candidate and transmission of the HANDOVER CANCEL message to the target candidate. In additional or alternative examples, the first network node may determine the second delay by determining an amount of time between the transmission of the HANDOVER REQUEST with a CHO indication and reception of the HANDOVER SUCCESS. In additional or alternative examples, the first network node may determine the second delay by determining an amount of time between the transmission of the HANDOVER REQUEST with a CHO indication and transmission of a HANDOVER CANCEL (or equivalent message from the first network node, e.g., Source gNodeB, to target candidate nodes where the UE has not executed CHO). In additional or alternative examples, the first network node may determine the second delay by determining an amount of time between the transmission of the HANDOVER REQUEST with a CHO indication and an internal event in the first network node.

In additional or alternative embodiments, the first network node may determine a third delay (e.g. CHO execution delay) upon reception of a HANDOVER SUCCESS message. Compared to the second delay, the third delay may exclude some potential processing delay at the source gNB transmitting the RRC Reconfiguration message to the UE.

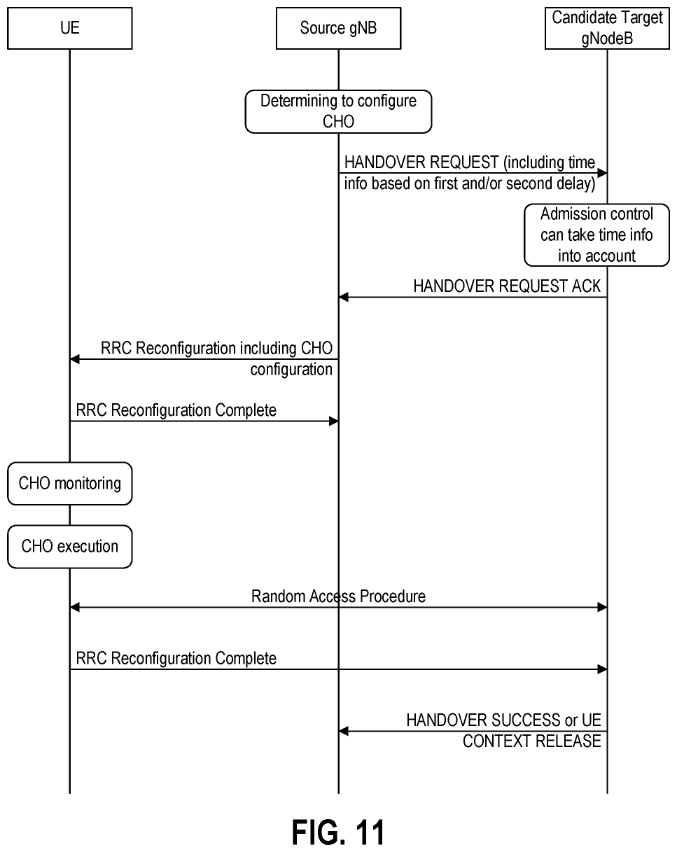

In some embodiments, the first network node uses the delay values. FIG. 11 illustrates an example of a first node using the delay values. The first node may transmit to a target candidate gNodeB an information derived based on the first delay values and/or the second delay values. The first node may receive a HANDOVER REQUEST ACKNOWLEDGE from a target candidate gNodeB. The first node may transmit to the UE a conditional reconfiguration.

The first network node may use information derived based on the first delay values to set the value of a preparation timer. The first network node may include in a message to the target candidate node a time duration value indicating how much time it is expected until the UE executes CHO.

In some embodiments, a second network node (e.g., a candidate target gNB) uses the delay values. The second network node (target candidate gNodeB) receives a message from the first network node (Source gNodeB) including a time duration value indicating how much time it is expected until the UE executes CHO. For example, the second network node may receive from the first node (e.g. Source gNodeB) the information derived based on the first delay values and/or the second delay and/or the third delay values. The second node may transmit a HANDOVER REQUEST ACKNOWLEDGE to the first network node (e.g. Source gNodeB). The second network node may generate for the UE a conditional reconfiguration. The second network node may use information derived based on the second delay values (provided from the first network node) to set a resource reservation timer.

In some embodiments, a UE may use the delay values. The UE receives a CHO configuration including a validity timer value. The UE starts the validity timer upon: expiry of the validity timer delete the CHO related configurations (associated to the timer that has expired) and stop monitoring CHO associated to the timer that has expired); logging the time elapsed from validity timer (or vice versa i.e. remaining time to expiry) in; or declaration of a failure (e.g., master cell group (“MCG”) radio link failure (“RLF”), secondary cell group (“SCG”) RLF, Handover failure) leads to the stop of the validity timer.

In some embodiments, a second network node (e.g., a candidate target gNB) determines delay values. The second network node receives from a first node a HANDOVER REQUEST including an indication that this is for CHO. The second network node transmits a HANDOVER REQUEST ACKNOWLEDGE message. The second network node determines a first delay (e.g. CHO preparation delay) upon transmitting the HANDOVER REQUEST ACKNOWLEDGE message, e.g. preparation delay, where the preparation delay is defined as the time between the reception of the HANDOVER REQUEST and the transmission of the HANDOVER REQUEST ACKNOWLEDGE message.

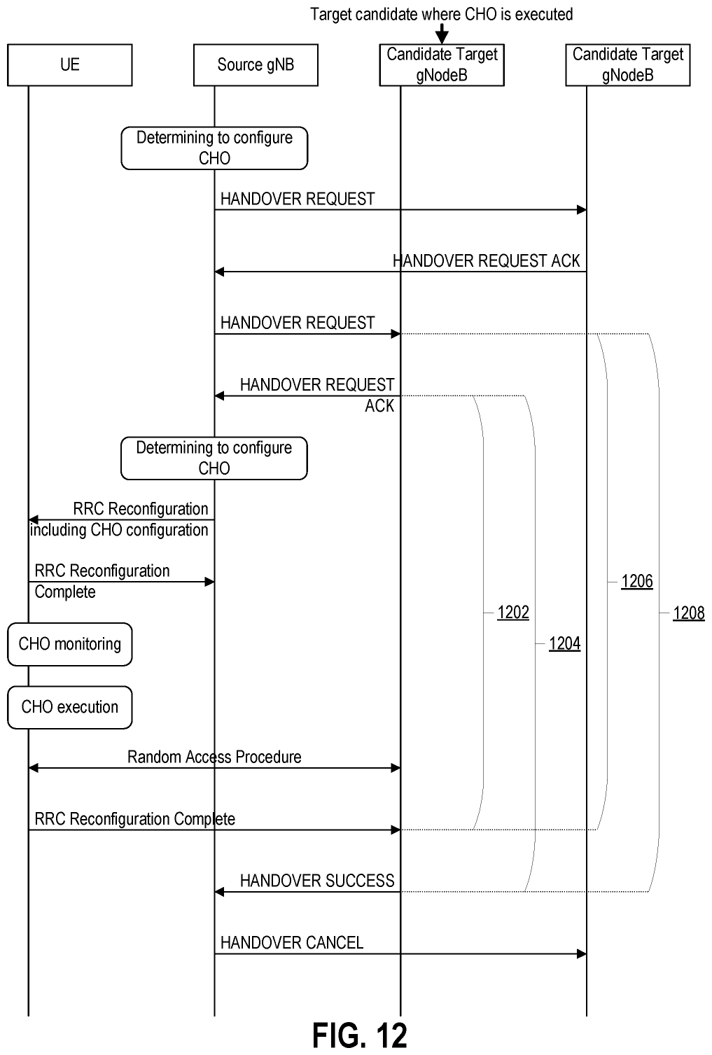

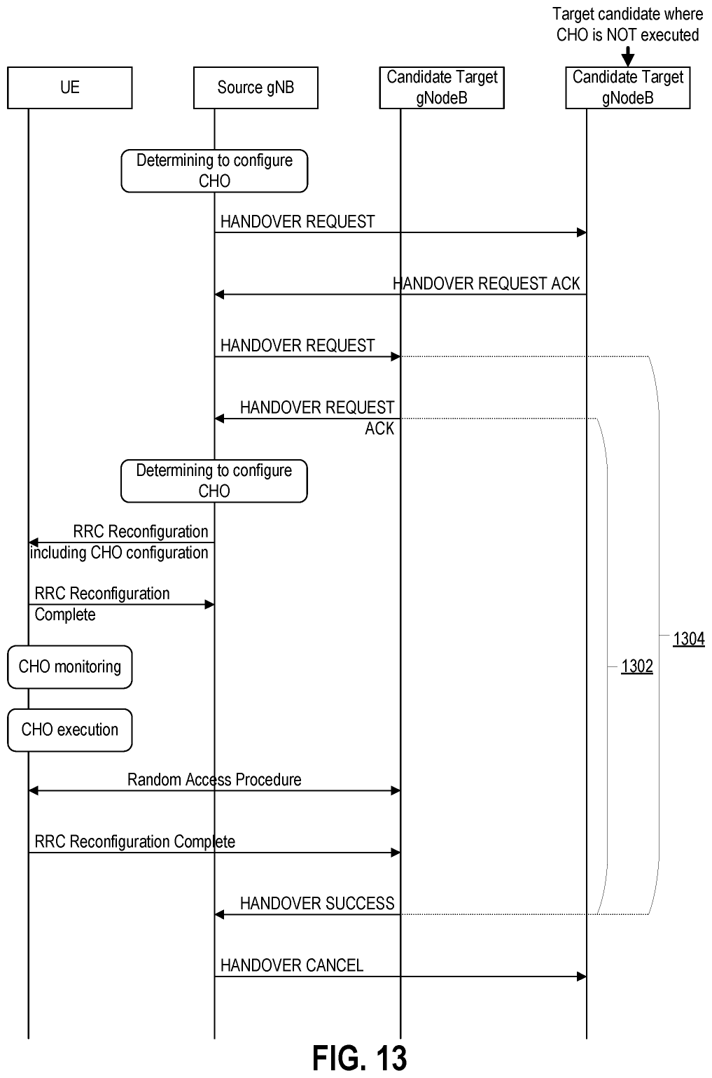

In additional or alternative embodiments, the second network node determining a second delay (e.g. CHO validity delay), the time duration (or estimation of the time duration) for which CHO resources in a target candidate have been reserved before a CHO execution occurred. This may be determined by the second network node (e.g. candidate target node, candidate target gNodeB) as the time between the transmission of the HANDOVER REQUEST ACKNOWLEDGE message to the source node and transmission of the HANDOVER SUCCESS to the first network node. FIGS. 12-13 illustrate examples of a second network node determining delay values. For example, FIG. 12 illustrates four examples of a second delay determined at a second node (second delay 1202, 1204, 1206, 1208) and FIG. 13 illustrates two examples of a second delay determined at a second node (second delay 1302, 1304).

In some embodiments, a second node (e.g., a target gNB candidate) uses delay values. For example, a target gNB candidate transmits to the first node (e.g. Source gNodeB) the information derived based on the first delay values and/or the second delay and/or the third delay values. The target gNB candidate transmits a HANDOVER REQUEST ACKNOWLEDGE from a target candidate gNodeB. The target gNB candidate transmits to the UE the information derived based on the first delay values and/or the second delay and/or the third delay values. In some examples, the information is transmitted within the RRC Reconfiguration message that is to be stored by the UE. In additional or alternative examples, the information is transmitted in the HANDOVER REQUEST ACKNOWLEDGE.

In some examples, the conditional reconfiguration contains a validity timer value. In additional or alternative examples, the validity timer value is configured per target candidate cell and is set by each target candidate node. In additional or alternative examples, the validity timer value is configured per target candidate node and is set by each target candidate node. In additional or alternative examples, the validity timer value is configured per target candidate cell and is set by the source node. In additional or alternative examples, the validity timer value is configured per target candidate node and is set by the source node.

The target gNB candidate uses information derived based on the second delay values to set a resource reservation timer for itself, i.e., for the candidate target network node. Upon expiry of the timer, CHO resources are released.

The second network node (e.g., target candidate gNodeB) transmits a message to the first network node (Source gNodeB) including a time duration value indicating for how much time it is reserving resources for CHO before the UE executes (e.g., after that time the second network node releases the resources). In some embodiments, the time duration value is included in the HANDOVER REQUEST ACKNOWLEDGE message in response to a CHO request. Based on the received value the first network node could accept or reject and, in case it rejects, it can send a HANDOVER CANCEL message to the target candidate.

The second network node performs admission control procedure based on the information derived from the first and second delay values. Depending on the result of the admission control procedure, the second network node transmits a HANDOVER REQUEST ACKNOWLEDGE or a HANDOVER REJECT.

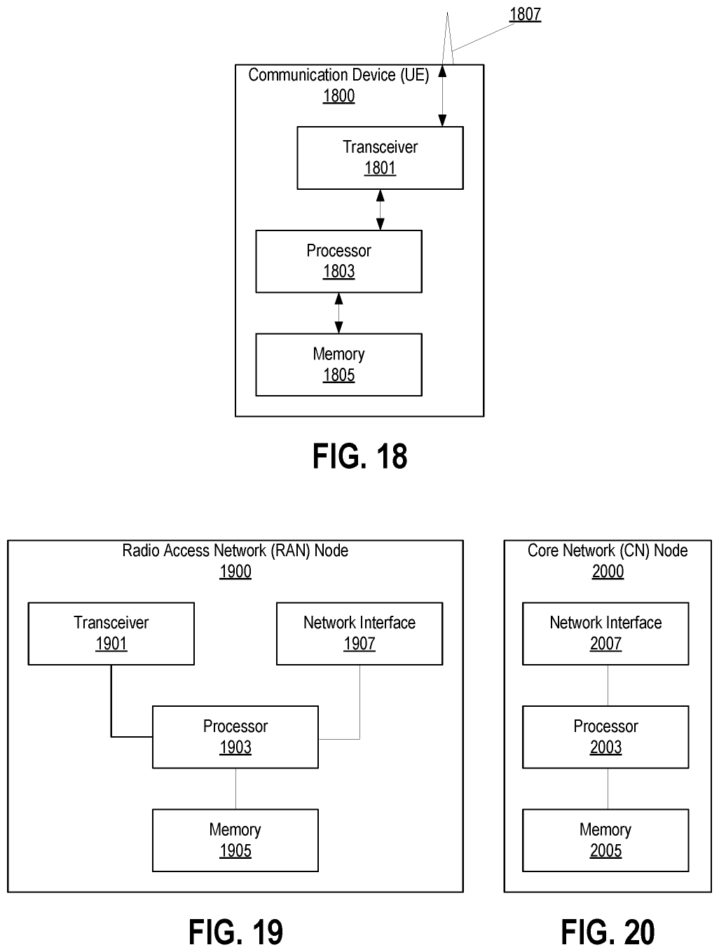

FIG. 18 is a block diagram illustrating elements of a communication device 1800 (also referred to as a mobile terminal, a mobile communication terminal, a wireless device, a wireless communication device, a wireless terminal, mobile device, a wireless communication terminal, user equipment (“UE”), a user equipment node/terminal/device, etc.) configured to provide wireless communication according to embodiments of inventive concepts. As shown, communication device 1800 may include an antenna 1807 and transceiver circuitry 1801 (also referred to as a transceiver,) including a transmitter and a receiver configured to provide uplink and downlink radio communications with a base station(s) (also referred to as a RAN node) of a radio access network. Communication device 1800 may also include processing circuitry 1803 (also referred to as a processor) coupled to the transceiver circuitry, and memory circuitry 1805 (also referred to as memory) coupled to the processing circuitry. The memory circuitry 1805 may include computer readable program code that when executed by the processing circuitry 1803 causes the processing circuitry to perform operations according to embodiments disclosed herein. According to other embodiments, processing circuitry 1803 may be defined to include memory so that separate memory circuitry is not required. Communication device 1800 may also include an interface (such as a user interface) coupled with processing circuitry 1803, and/or communication device may be incorporated in a vehicle.

As discussed herein, operations of communication device 1800 may be performed by processing circuitry 1803 and/or transceiver circuitry 1801. For example, processing circuitry 1803 may control transceiver circuitry 1801 to transmit communications through transceiver circuitry 1801 over a radio interface to a radio access network node (also referred to as a base station) and/or to receive communications through transceiver circuitry 1801 from a RAN node over a radio interface. Moreover, modules may be stored in memory circuitry 1805, and these modules may provide instructions so that when instructions of a module are executed by processing circuitry 1803, processing circuitry 1803 performs respective operations.

FIG. 19 is a block diagram illustrating elements of a radio access network (“RAN”) node 1900 (also referred to as a network node, base station, eNodeB/eNB, gNodeB/gNB, etc.) of a Radio Access Network (“RAN”) configured to provide cellular communication according to embodiments of inventive concepts. As shown, the RAN node 1900 may include transceiver circuitry 1901 (also referred to as a transceiver) including a transmitter and a receiver configured to provide uplink and downlink radio communications with mobile terminals. The RAN node 1900 may include network interface circuitry 1907 (also referred to as a network interface) configured to provide communications with other nodes (e.g., with other base stations) of the RAN and/or core network CN. The RAN node 1900 may also include processing circuitry 1903 (also referred to as a processor) coupled to the transceiver circuitry, and memory circuitry 1905 (also referred to as memory) coupled to the processing circuitry. The memory circuitry 1905 may include computer readable program code that when executed by the processing circuitry 1903 causes the processing circuitry to perform operations according to embodiments disclosed herein. According to other embodiments, processing circuitry 1903 may be defined to include memory so that a separate memory circuitry is not required.

As discussed herein, operations of the RAN node 1900 may be performed by processing circuitry 1903, network interface 1907, and/or transceiver 1901. For example, processing circuitry 1903 may control transceiver 1901 to transmit downlink communications through transceiver 1901 over a radio interface to one or more mobile terminals UEs and/or to receive uplink communications through transceiver 1901 from one or more mobile terminals UEs over a radio interface. Similarly, processing circuitry 1903 may control network interface 1907 to transmit communications through network interface 1907 to one or more other network nodes and/or to receive communications through network interface from one or more other network nodes. Moreover, modules may be stored in memory 1905, and these modules may provide instructions so that when instructions of a module are executed by processing circuitry 1903, processing circuitry 1903 performs respective operations (e.g., operations discussed below with respect to Example Embodiments relating to network nodes).

According to some other embodiments, a network node may be implemented as a core network CN node without a transceiver. In such embodiments, transmission to a wireless communication device may be initiated by the network node so that transmission to the wireless communication device is provided through a network node including a transceiver (e.g., through a base station or RAN node). According to embodiments where the network node is a RAN node including a transceiver, initiating transmission may include transmitting through the transceiver.

FIG. 20 is a block diagram illustrating elements of a core network (“CN”) node 2000 (e.g., a session management function (“SMF”) node, an access and mobility management function (“AMF”) node, etc.) of a communication network configured to provide cellular communication according to embodiments of inventive concepts. As shown, the CN node 2000 may include network interface circuitry 2007 (also referred to as a network interface) configured to provide communications with other nodes of the core network and/or the RAN. The CN node 2000 may also include a processing circuitry 2003 (also referred to as a processor) coupled to the network interface circuitry, and memory circuitry 2005 (also referred to as memory) coupled to the processing circuitry. The memory circuitry 2005 may include computer readable program code that when executed by the processing circuitry 2003 causes the processing circuitry to perform operations according to embodiments disclosed herein. According to other embodiments, processing circuitry 2003 may be defined to include memory so that a separate memory circuitry is not required.

As discussed herein, operations of the CN node 2000 may be performed by processing circuitry 2003 and/or network interface circuitry 2007. For example, processing circuitry 2003 may control network interface circuitry 2007 to transmit communications through network interface circuitry 2007 to one or more other network nodes and/or to receive communications through network interface circuitry from one or more other network nodes. Moreover, modules may be stored in memory 2005, and these modules may provide instructions so that when instructions of a module are executed by processing circuitry 2003, processing circuitry 2003 performs respective operations (e.g., operations discussed below with respect to Example Embodiments relating to network nodes).

In the following disclosure, the term Conditional Handover (“CHO”) is used generally and includes similar terms including conditional reconfiguration, or Conditional Configuration (since the message that is stored and applied upon fulfillment of a condition is an RRCReconfiguration or RRCConnectionReconfiguration). CHO may also be interpreted more broadly, for example, the delays calculations and procedures related (e.g. signaling, setting of parameters based on the calculations, etc.) are also applicable to Conditional primary secondary cell (“PSCell”) Change or Conditional PSCell Addition procedure, where a target candidate node (e.g. gNodeB) also reserve resources for an incoming UE in a continuous packet connectivity (“CPC”) procedure. The second delay, for example, would be the time duration a target candidate for secondary node (“SN”) addition would have to reserve resource before the conditional reconfiguration execution. The principle for the configuration is the same with configuring triggering/execution condition(s) and a reconfiguration message to be applied when the triggering condition(s) are fulfilled.

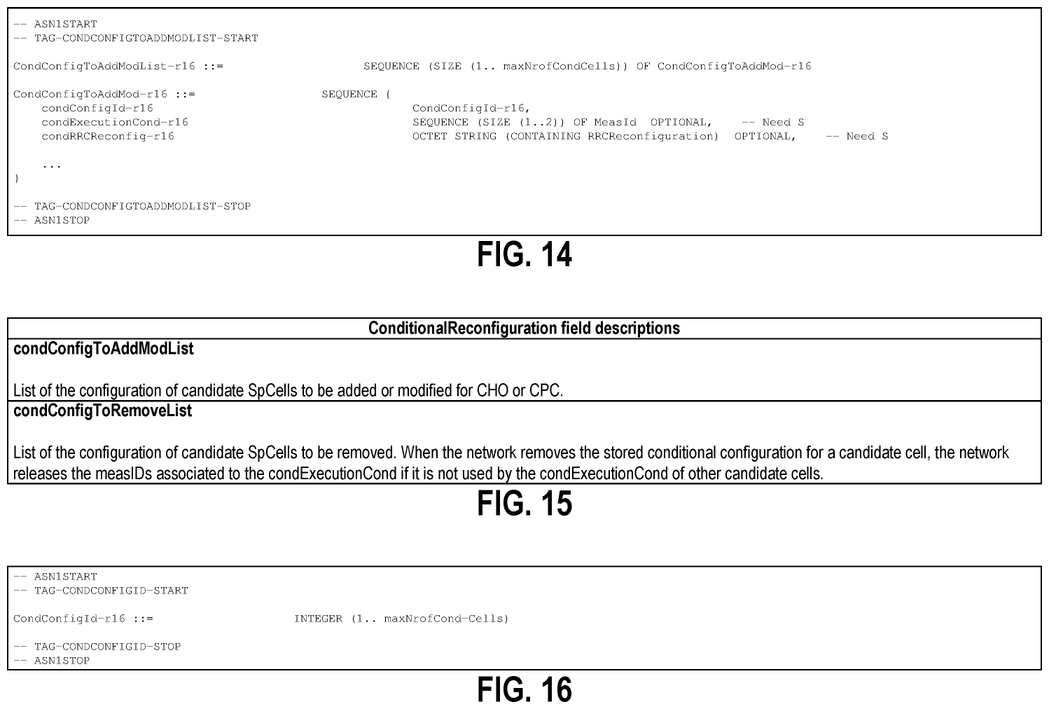

FIG. 14 is computer code illustrating an example of the IE ConditionalReconfiguration, which can be used to add, modify, and release the configuration of conditional configuration. The table in FIG. 15 illustrates an example of ConditionalReconfiguration field descriptions. FIG. 16 is computer code illustrating an example of the IE CondConfigId, which is used to identify a CHO or CPC configuration.

In some embodiments, a first node (e.g., a source gNB) determines delay values for configuring CHO. The first node determines to configure CHO to a wireless terminal (also called a user equipment or communication device). In some examples, the first node determines one or more target cells and determines the associated candidate node(s) (e.g. gNodeB(s)).

In some embodiments, the first node transmits to each target node candidate at least one HANDOVER REQUEST including an indication that this is for CHO. Therefore, for a given candidate target node, there is at least one target candidate cell. However, the source gNodeB may request CHO for multiple target candidate cells associated to a given target candidate node and transmit a HANDOVER REQUEST message for each target candidate cell to that node. In some examples, the indication can be included in Conditional Handover Information.

The first node receives from each target node candidate at least one HANDOVER REQUEST ACKNOWLEDGE message. Therefore, for a given candidate target node there is at least one target candidate cell. However, the source gNodeB may request CHO for multiple target candidate cells associated to a given target candidate node and transmit a HANDOVER REQUEST message for each target candidate cell to that node.

The first node determines a first delay (e.g., a CHO preparation delay) upon receiving a HANDOVER REQUEST ACKNOWLEDGE message. The first delay can indicate the time between the transmission of the HANDOVER REQUEST with a CHO indication and the reception of the HANDOVER REQUEST ACKNOWLEDGE message. In some examples, the first node can store the first delay in a memory (e.g. to be possibly retrieved by an Operations and Management (“OAM”) system). As the HANDOVER REQUEST and HANDOVER REQUEST ACKNOWLEDGE messages are used for both legacy and CHO, distinguishing the first delay for each procedure type. The distinction may be done by defining different related counters and/or events, traces, logs, etc. In additional or alternative examples, the first node can transmit the first delay to an OAM node (e.g. upon retrieval/request), a self-organizing network (“SON”) function node; or another node associated with a RAN algorithm.

The first node transmits an RRC Reconfiguration message to the UE including CHO configuration (e.g. conditional reconfiguration) for one or more target cell candidates associated to one or target node candidates.

In additional or alternative embodiments, the first node determines a second delay (e.g. CHO validity delay). The second delay can indicate the time duration for which CHO resources in a target candidate have been reserved before a CHO execution occurred.

In some embodiments, the second delay is the time duration between the reception of the HANDOVER REQUEST ACKNOWLEDGE message from the target candidate and reception of the HANDOVER SUCCESS from the target candidate. For example, the first network node requests CHO for UE(1) with a target gNodeB(1) and after X seconds the first network node has received a HANDOVER SUCCESS from target gNodeB(1) for the incoming UE(1) that has executed CHO in the target gNodeB(1). In this example, the second delay would have the value of X seconds. The second delay in this example could be associated to the target candidate gNodeB(1).

In additional or alternative embodiments, the second delay is the time duration between the transmission of the HANDOVER REQUEST with a CHO indication and reception of the HANDOVER SUCCESS. For example, the first network node requests CHO for UE(1) with a target gNodeB(1) and after X seconds the first network node has received a HANDOVER SUCCESS from target gNodeB(1) for the incoming UE(1) that has executed CHO in the target gNodeB(1). In this example, the second delay would have the value of X seconds. The second delay in this example could be associated to the target candidate gNodeB(1).

In additional or alternative embodiments, the second delay is the time duration between the transmission of the HANDOVER REQUEST with a CHO indication and transmission of a HANDOVER CANCEL (or equivalent message from the first network node (e.g., source gNodeB) to target candidate nodes where the UE has not executed CHO). For example, the first network node requests CHO for UE(1) with a target gNodeB(1) and a target gNodeB(2); after X seconds the first network node has received a HANDOVER SUCCESS from target gNodeB(1) for the incoming UE(1) that has executed CHO in the target gNodeB(1), and X2 milliseconds later it transmits a HANDOVER CANCEL message to target gNodeB(2). In this example, the second delay would have the value of X+X2 seconds. The second delay in this example could be associated to the target candidate gNodeB(2).

In additional or alternative embodiments, the second delay is the time duration between the transmission of the HANDOVER REQUEST with a CHO indication and an internal event in the first network node. The internal event can include: transmission of an RRC Release to the UE (e.g. to transition the UE to RRC_INACTIVE or RRC_CONNECTED); detection of a failure; or transmitting RRC Reconfiguration with an updated list of target candidates before reception HANDOVER SUCCESS message or UE CONTEXT RELEASE message.

In additional or alternative embodiments, the second delay value, for a given UE, is the time between the transmission of the HANDOVER REQUEST and the reception of the UE CONTEXT RELEASE message associated to the same UE.

In additional or alternative embodiments, the second delay value, for a given UE, is the time between the reception of the HANDOVER REQUEST ACKNOWLEDGE message until the reception of the UE CONTEXT RELEASE message associated to the same UE.

In some embodiments, the message is from the UE that has executed CHO. In additional or alternative embodiments, the message is from a target candidate node.

In some embodiments, the first node stores the second delay in its memory (e.g. to be possibly retrieved by an OAM system). As the messages are used for both legacy and CHO, distinguishing the first delay for each procedure type. In some examples, the first node transmits the second delay to an OAM node (e.g. upon retrieval/request). In additional or alternative embodiments, the first node transmits the second delay to a node performing Machine Learning training for a prediction model.

In some embodiments, a granularity for the second delay is per CHO procedure for a given UE and target candidate node. A second delay may be defined one way for the target candidate where the UE executes (duration until the reception if the HANDOVER SUCCESS message) and another way for the target candidate where the UE does not execute (duration until the transmission of the HANDOVER CANCEL message). There may be different levels of granularity for the second delay. For example: per UE (as described in the determination above); per candidate target node; per candidate target cell; per service; per bearer; per bearer group; and/or per source node.

The second delay can indicate for how long a candidate node needed to reserve resources for CHO for a given UE (or target node and/or cell for a given UE). That may indicate to the OAM system and/or any other function (e.g., a SON function) performing data analyses of traces and/or pm counters.

In some embodiments, the first node (e.g. the source gNodeB) uses timers to compute the first and/or the second CHO delay(s). In some examples, for the first delay, a timer is started upon the transmission to each target node candidate of at least one HANDOVER REQUEST including an indication that this is for CHO. The timer is stopped upon the reception of a HANDOVER REQUEST ACKNOWLEDGE message. The first delay is the value of the elapsed time for the timer.

In some examples, for the second delay, a timer is started upon the transmission to each target node candidate of at least one HANDOVER REQUEST including an indication that this is for CHO. The timer is stopped upon the reception of a HANDOVER SUCCESS message. The second delay is the value of the elapsed time for the timer. In additional or alternative examples, for the second delay, a timer is started upon the transmission to each target node candidate of at least one HANDOVER REQUEST including an indication that this is for CHO. The timer is stopped upon the reception of a UE CONTEXT RELEASE message. The second delay is the value of the elapsed time for the timer.

In some embodiments, a Performance Monitoring (“PM”) counter is defined based on the second delay or the first delay, for example, a number of values above an X seconds threshold, counters per interval so that a distribution is computed. In additional or alternative embodiments a PM event is defined based on the second delay or the first delay e.g. a trace with an exact value per procedure and/or UE and/or cell and/or message and/or flow and/or bearer and/or any other granularity.

In case of transmitting RRC Reconfiguration with an updated list of target candidates before the reception of HANDOVER SUCCESS message or UE CONTEXT RELEASE message.

FIG. 10 illustrates an example of how the second delay may be determined. The first network node (e.g., source gNB, Source gNodeB) can use information derived based on the first delay values to set the value of a preparation timer. In some embodiments, the source NG-RAN node initiates the Handover preparation procedure for CHO by sending the HANDOVER REQUEST message to the target next generation RAN (“NG-RAN”) node. When the source NG-RAN node sends the HANDOVER REQUEST message, it starts the timer TXnRELOCprep, whose value has been set based on the information derived based on the first delay values to set a preparation timer, for example, for a given target network node.

The first network node source gNodeB includes in a message to the target candidate node a time duration value indicating how much time it is expected until the UE executes CHO. In some examples, the time duration value is included in the HANDOVER REQUEST message with a CHO indication. Upon reception at the target candidate, the target candidate's admission control function is aware of for how long it needs to reserve CHO resources (such as contention free random-access resources). In additional or alternative examples, the value is determined based on information derived from the second delay.

In some embodiments, the first node determines a third delay (e.g., CHO execution delay). In some examples, the third delay is determined upon reception of a HANDOVER SUCCESS message. In additional or alternative examples, compared to the second delay, the third delay excludes some potential processing delay at the source gNB transmitting the RRC reconfiguration message to the UE.

FIG. 11 illustrates an example of the first network node (e.g., source gNB) using delay values. The first node transmits to a target candidate gNodeB an information derived based on the first delay values and/or the second delay values. In some examples, the first node transmits a HANDOVER REQUEST message to a target candidate gNodeB including an information derived based on the first delay values and/or the second delay values. The information may be transmitted in a HANDOVER REQUEST message to a target candidate after collecting statistics for the first and/or second delay values during a time interval, or for the sub-sequent CHO. The information may be transmitted in the next HANDOVER REQUEST message to a target candidate. For example, CHO is configured and the first and second delay values for that is calculated. Next time CHO is request (i.e. next time HANDOVER REQUEST is transmitted from the source to a target candidate) the previous value(s) or the first delay and/second delay is included. That may give the target candidate an idea of how long it took the previous time CHO was request.

In additional or alternative examples, the first node may transmit a HANDOVER CANCEL message to a target candidate gNodeB including an information derived based on the first delay values and/or the second delay values. The information may be transmitted in a HANDOVER CANCEL message to a target candidate after collecting statistics for the first and/or second delay values during a time interval, or for the sub-sequent CHO. The information may be transmitted in a HANDOVER CANCEL message to the target candidates where the procedure is not executed.

In additional or alternative examples, the first node may transmit another XnAP message to a target candidate gNodeB including an information derived based on the first delay values and/or the second delay values.

The information may be derived based on the first delay value and/or the second delay value may be an average of first delay and/or second delay values. For example, gNodeB determines for following values in a time interval (1, 5, 10, 15, 20) have an average of 10.2 seconds. That may indicate to the target node candidate that, according to previous statistics, it has taken in average 10.2 seconds between CHO configuration and execution (or release of resources). In some examples, this is a weighted average (e.g., latest samples having higher coefficients).

The information may be derived based on a maximum value of the first delay and/or second delay values. For example, gNodeB determines the following values in a time interval (1, 5, 10, 15, 20) have a maximum value of 20 seconds. That may indicate to the target node candidate that, according to previous statistics, it has taken at most 20 seconds between CHO configuration and execution (or release of resources).

The information may be derived based on a standard deviation value of the first delay and/or second delay values. For example, gNodeB determines the following values in a time interval (1, 5, 10, 15, 20) have a maximum value of 20 seconds. That may indicate to the target node candidate how spread values are according to previous statistics.

The information may be derived based on a distributions for the first delay and/or second delay values. For example, gNodeB transmits to target node candidate for following values in a time interval (1, 5, 10, 15, 20), a probability distribution function (“PDF”) and/or cumulative distribution function (“CDF') and/or histogram.

The information derived based on the first delay values and/or the second delay values can indicate to the candidate target node how long the CHO resources are being requested to be reserved.

In additional or alternative embodiments, the first network node receives a HANDOVER REQUEST ACKNOWLEDGE from a target candidate gNodeB. In some examples, the HANDOVER REQUEST ACKNOWLEDGE message can include a validity timer value derived based on the information derived based on the first delay values and/or the second delay values. In additional or alternative examples, the timer value within the HANDOVER REQUEST ACKNOWLEDGE message includes a validity timer value within the RRC Reconfiguration message from the UE to the network.

In additional or alternative embodiments, the first network node transmits a conditional reconfiguration to the UE. In some examples, the conditional reconfiguration contains a validity timer value. In additional or alternative examples, the validity timer value is configured per target candidate cell and is set by each target candidate node (e.g., like the configuration to timer T304). In additional or alternative examples, the validity timer value is configured per target candidate node and is set by each target candidate node. In additional or alternative examples, the validity timer value is configured per target candidate cell and is set by the source node. In additional or alternative examples, the validity timer value is configured per target candidate node and is set by the source node.

In some embodiments, a second node (e.g. target gNB candidate) for configuring CHO (conditional reconfiguration) uses the delay values. The second node receives from the first node (e.g. Source gNodeB) the information derived based on the first delay values and/or the second delay values. In some examples, the second node receives a HANDOVER REQUEST message from the first node including the information derived based on the first delay values and/or the second delay values. In additional or alternative examples, a second node receives a HANDOVER CANCEL message from the first node including the information derived based on the first delay values and/or the second delay values. That may be done in a HANDOVER CANCEL message to a target candidate after collecting statistics for the first and/or second delay values during a time interval, or for the sub-sequent CHO. That may be done in a HANDOVER CANCEL message to the target candidates where the procedure is not executed.

In additional or alternative examples, the second node can receive another XnAP message including an information derived based on the first delay values and/or the second delay values.

The information derived based in the first delay value and/or the second delay value may be an average of first delay and/or second delay values e.g. gNodeB determines for following values in a time interval (1, 5, 10, 15, 20) having an average of 10.2 seconds. That may indicate to the target node candidate that, according to previous statistics, it has taken in average 10.2 seconds between CHO configuration and execution (or release of resources). The average may be a weighted average (e.g., latest samples having higher coefficients).

The information may be derived based on a maximum value of the first delay and/or second delay values e.g. gNodeB determines the following values in a time interval (1, 5, 10, 15, 20) has a maximum value of 20 seconds. That may indicate to the target node candidate that, according to previous statistics, it has taken at most 20 seconds between CHO configuration and execution (or release of resources).

The information may be derived based on a standard deviation value of the first delay and/or second delay values e.g. gNodeB determines the following values in a time interval (1, 5, 10, 15, 20) has a maximum value of 20 seconds. That may indicate to the target node candidate how spread values are according to previous statistics.

The information may be derived based on a distributions for the first delay and/or second delay values.

The information derived based on the first delay values and/or the second delay values can indicate to the candidate target node for how long the CHO resources are being requested to be reserved.

The information derived based on the first delay values and/or the second delay values can be used as input to the admission control mechanism at the candidate target node. For example, if the time value is longer than a defined threshold for the amount of time the candidate target node is willing to allocate resources for CHO, the candidate target node rejects the request (e.g. sends an NACK message in response). Otherwise, it sends a HANDOVER REQUEST ACKNOWLEDGE with the RRCReconfiguration.

In additional or alternative embodiments, the second node transmits a HANDOVER REQUEST ACKNOWLEDGE to the first network node (e.g. Source gNodeB). In some examples, the HANDOVER REQUEST ACKNOWLEDGE message includes a validity timer value e.g. derived based on the information derived based on the first delay values and/or the second delay values. In additional or alternative examples, the timer value within the HANDOVER REQUEST ACKNOWLEDGE message includes a validity timer value within the RRC Reconfiguration message from the UE to the network.

In additional or alternative embodiments, the second node transmits to the UE a conditional reconfiguration. In some examples, the conditional reconfiguration contains a validity timer value. In additional or alternative examples, the validity timer value is configured per target candidate cell and is set by each target candidate node. In additional or alternative examples, the validity timer value is configured per target candidate node and is set by each target candidate node. In additional or alternative examples, the validity timer value is configured per target candidate cell and is set by the source node. In additional or alternative examples, the validity timer value is configured per target candidate node and is set by the source node.

In additional or alternative embodiments, the second node uses information derived based on the second delay values (provided from the first network node) to set a resource reservation timer. This timer can be started upon reception of a HANDOVER REQUEST message with CHO indication, and to be stopped upon the detection of a CHO or HO execution for the UE for which CHO has been configured. In some examples, the second network node detects CHO or HO execution for the UE for which CHO has been configured by the reception of an RRC Reconfiguration Complete from the UE. In additional or alternative examples, the second network node detects CHO or HO execution for the UE for which CHO has been configured by the reception of a HANDOVER CANCEL from the first network node. Upon expiry of the timer the CHO resources can be released.

In some embodiments, the second network node (e.g., a target candidate gNodeB) receives a message from the first network node (e.g., a Source gNodeB) including a time duration value indicating how much time is expected until the UE executes CHO. In some examples, the time duration value is included in the HANDOVER REQUEST message with a CHO indication. Upon reception at the target candidate, the target candidate's admission control function is aware of for how long it needs to reserve CHO resources (such as contention free random-access resources). The target's admission control function may have a time value threshold (possibly configured by OAM) so that if the time duration value is greater than a time value threshold the CHO request is rejected and if the time duration value is less than the time value threshold the CHO request is accepted.

In some examples, if the CHO request is rejected, the second network node transmits a HANDOVER PREPARATION FAILURE. In additional or alternative examples, a cause value in HANDOVER PREPARATION FAILURE is defined to indicate to the first network node (e.g. source gNodeB) that the reason the CHO request was rejected was due to the fact that the time duration value was higher than a defined threshold. In additional or alternative examples, the message may also include the target candidate acceptance's level so the first network node has the opportunity to trigger a sub-sequent request, but with a time duration value that would be acceptable by the target candidate node.

In some examples, if the CHO request is accepted, the second network node transmits a HANDOVER REQUEST ACKNOWLEDGE. In additional or alternative examples, the value is determined based on information derived from the second delay.

In some embodiments, a UE uses the delay values. The UE receives a CHO configuration including a validity timer value. In some examples, the timer value has at least one of the following granularities: per target candidate; per CHO configuration (i.e. the list of target candidate configurations); and per group of target candidates (e.g. node value). In additional or alternative examples, the timer value is set by the candidate target node, for example, within RRCReconfiguration in container, or outside so same value is set for a group of cells (possibly from the same target node). In additional or alternative examples, the timer value is set by the source node, for example, outside the RRCReconfiguration per target candidate. In additional or alternative examples, the timer value is optional. If the timer value is provided, the UE starts the timer upon reception of the message (or upon starting to monitor conditions e.g. successful configuration of trigger/execution conditions). The UE stops the timer upon CHO execution, HO execution, RLF, and HOF. Upon expiry, the UE deletes associated CHO configurations, stops monitoring trigger conditions, deletes the associated measConfig, and/or sends a message to source node.

In additional or alternative embodiments, the UE starts the validity timer upon receiving a CHO configuration containing a validity timer.

In additional or alternative embodiments, upon expiry of the validity timer, the UE deletes the CHO related configurations (associated to the timer that has expired) and stops monitoring CHO associated to the timer that has expired.

In additional or alternative embodiments, the UE logs the time elapsed from validity timer (of vice versa i.e. remaining time to expiry). In some examples, the UE stores the time elapsed from the validity timer in a RLF report to be transmitted to network if RLF occurs while CHO is being monitored. In additional or alternative examples, the UE stores the time elapsed from the validity timer in a HOF report to be transmitted to network if HOF occurs while CHO or HO is being executed, while UE has CHO configurations. In additional or alternative examples, the UE stores the time elapsed from the validity timer in a SCG failure report to be transmitted to network if SCG failure occurs in CHO like events. In additional or alternative examples, the UE stores the time elapsed from the validity timer in a MCG failure report to be transmitted to network if SCG failure occurs in CHO like events;

In additional or alternative embodiments, the UE declares a failure (e.g. MCG RLF, SCG RLF, Handover failure) leading to the stop of the validity timer.

In some embodiments, a second network node (e.g., a candidate Target gNB) determines delay values. The second network node receives from a first node a HANDOVER REQUEST including an indication that this is for CHO. For a given candidate target node there is at least one target candidate cell. However, the source gNodeB may request CHO for multiple target candidate cells associated to a given target candidate node and transmit a HANDOVER REQUEST message for each target candidate cell to that node. The indication can be a Conditional Handover Information.

In additional or alternative embodiments, the second network node transmits a HANDOVER REQUEST ACKNOWLEDGE message. For a given candidate target node there is at least one target candidate cell. However, the source gNodeB may request CHO for multiple target candidate cells associated to a given target candidate node and would transmit a HANDOVER REQUEST message for each target candidate cell to that node.

In additional or alternative embodiments, the second network node determines a first delay (e.g. CHO preparation delay) upon transmitting the HANDOVER REQUEST ACKNOWLEDGE message, e.g. preparation delay, where the preparation delay is defined as the time between the reception of the HANDOVER REQUEST and the transmission of the HANDOVER REQUEST ACKNOWLEDGE message. In some examples, the second network node stores the first delay in a memory (e.g. to be possibly retrieved by an OAM system). As the HANDOVER REQUEST and HANDOVER REQUEST ACKNOWLEDGE messages are used for both legacy and CHO, distinguishing the first delay for each procedure type i.e. legacy and CHO. In additional or alternative examples, the second network node transmits the first delay to an OAM node (e.g. upon retrieval/request).

In additional or alternative embodiments, the second network node determines a second delay (e.g. CHO validity delay) defined as the time duration (or estimation of the time duration) for which CHO resources in a target candidate have been reserved before a CHO execution occurred. In some examples, the second delay is determined as the time between the transmission of the HANDOVER REQUEST ACKNOWLEDGE message to the source node and transmission of the HANDOVER SUCCESS to the first network node. The second node may be a target candidate where CHO has been executed (hence it receives from the UE an RRC Reconfiguration Complete). In additional or alternative examples, the second delay is determined as the time between the reception of the HANDOVER REQUEST message to the source node and transmission of the HANDOVER SUCCESS to the first network node. The second node can be a target candidate where CHO has been executed (hence it receives from the UE an RRC Reconfiguration Complete). In additional or alternative examples, the second delay is determined as the time between the transmission of the HANDOVER REQUEST ACKNOWLEDGE message to the source node and reception of the RRC Reconfiguration Complete from the UE. In additional or alternative examples, the second delay is determined as the time between the reception of the HANDOVER REQUEST message from the source node and reception of the RRC Reconfiguration Complete from the UE as illustrated in FIG. 12.

In additional or alternative examples, the second delay is determined as the time between the transmission of the HANDOVER REQUEST ACKNOWLEDGE message to the source node and reception of the HANDOVER CANCEL from the first network node. The second node is a target candidate where CHO has not been executed. Hence, it receives from the first network node a HANDOVER CANCEL, wherein the first network node sends that upon receiving a HANDOVER SUCCESS from another network node where the UE has executed CHO or it is canceling due to other internal reasons, such as transitioning the UE to RRC_IDLE or RRC_INACTIVE). Even in that example, it is useful for the second network node to know for how long resources have been reserved but not utilized, so that it may build statistics concerning how long it had to reserve resources for CHO for a given Source requesting it. This may be used as input in the admission control function.

FIG. 13 illustrates an additional or alternative example in which the second delay is determined as the time between the reception of the HANDOVER REQUEST with a CHO indication and reception of the HANDOVER CANCEL from the first network node. In this example, the second node is a target candidate where CHO has not been executed (hence it receives from the first network node a HANDOVER CANCEL, wherein the first network node sends that upon receiving a HANDOVER SUCCESS from another network node where the UE has executed CHO). In this example, it is useful for the second network node to know for how long resources have been reserved but not utilized, so that it may build statistics concerning how long it had to reserve resources for CHO for a given Source requesting it. This may be used as input in the admission control function.

As illustrated in FIGS. 12-13, the second delay can be determined at a candidate target network node where CHO is executed or at a candidate target network node where CHO is not executed.

The second network node can store the second delay in its memory (e.g. to be possibly retrieved by an OAM system). As the messages are used for both legacy and CHO, distinguishing the first delay for each procedure type i.e. legacy and CHO.

The second network node can transmit the second delay to an OAM node (e.g. upon retrieval/request).

There may be different levels of granularity for the second delay including: per UE (as described in the determination above); per candidate target node; per candidate target cell; per service; per bearer; per bearer group; and per source node.

The second delay can indicate for how long a candidate node needed to reserve resources for CHO for a given UE (or target node and/or cell for a given UE). That may indicate to the OAM system and/or any other function performing data analyses of traces and/or pm counters.

In some embodiments, the second node (e.g. the target gNodeB) uses timers to compute the first and/or the second CHO delay(s). For the first delay, for example, a timer is started upon the reception off a HANDOVER REQUEST including an indication that this is for CHO. The timer is stopped upon the transmission of a HANDOVER REQUEST ACKNOWLEDGE message. The first delay is the value of the elapsed time for the timer. For the second delay, for example, a timer is started upon the reception of a HANDOVER REQUEST including an indication that this is for CHO. The timer is stopped upon the transmission of a HANDOVER SUCCESS message. The second delay is the value of the elapsed time for the timer. For the second delay, for example, a timer is started upon the reception of a HANDOVER REQUEST including an indication that this is for CHO. The timer is stopped upon the transmission of a UE CONTEXT RELEASE message. The second delay is the value of the elapsed time for the timer.

In additional or alternative embodiments, a Performance Monitoring, PM counter is defined based on the second delay or the first delay e.g. number of values above an X seconds threshold, counters per interval so that a distribution is computed. In additional or alternative embodiments, a PM event is defined based on the second delay or the first delay e.g. a trace with an exact value per procedure and/or UE and/or cell and/or message and/or flow and/or bearer and/or any other granularity.

Having the second network node determine the delay values can result in the target node being responsible to compute for how long it has to reserve resources for a given CHO procedure/UE from request node. That information could be used as input to admission control for later requests from the same node.

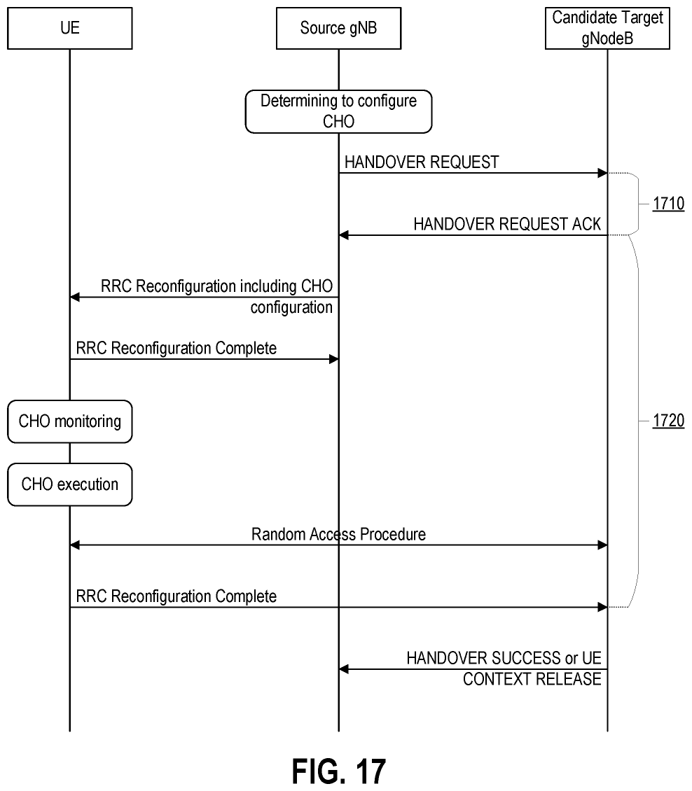

FIG. 17 illustrates an example of a second network determining delay values. In some embodiments, a fourth delay is determined at the second network node, which is a candidate target node, comprising the time it takes from the UE starting random access (e.g. first preamble transmission attempt after CHO execution) until the time is transmits the RRC Reconfiguration Complete. By determining that delay it should be possible to know how long it took for the UE to apply the stored RRC Reconfiguration message.

In some embodiments, the second network node uses the delay values. The second network node transmits to the first node (e.g. Source gNodeB) the information derived based on the first delay values and/or the second delay and/or the third delay values. In some examples, the second network node transmits a HANDOVER REQUEST ACK message to the first node including the information derived based on the first delay values and/or the second delay values. In additional or alternative examples, the second network node transmits a HANDOVER SUCCESS message to the first node including the information derived based on the first delay values 1710 and/or the second delay values 1720. That may be done in a HANDOVER SUCCESS message to the Source after collecting statistics for the first and/or second delay values during a time interval, or for the sub-sequent CHO. In additional or alternative examples, the second network node transmits another XnAP message to the source gNodeB including an information derived based on the first delay values and/or the second delay values.

In additional or alternative examples, the information derived based in the first delay value and/or the second delay value may be an average of first delay and/or second delay values e.g. gNodeB determines for following values in a time interval (1, 5, 10, 15, 20) having an average of 10.2 seconds. That may indicate to the Source that, according to previous statistics, it has taken in average 10.2 seconds between CHO configuration and execution (or release of resources). The average may be a weighted average (e.g. latest samples having higher coefficients).

The information may be derived based on a maximum value of the first delay and/or second delay values e.g. gNodeB determines the following values in a time interval (1, 5, 10, 15, 20) having a maximum value of 20 seconds. That may indicate to the Source node that, according to previous statistics, it has taken at most 20 seconds between CHO configuration and execution (or release of resources).

The information may be derived based on a standard deviation value of the first delay and/or second delay values e.g. gNodeB determines the following values in a time interval (1, 5, 10, 15, 20) having a maximum value of 20 seconds. That may indicate to the Source node how spread values are according to previous statistics.

The information may be derived based on distributions for the first delay and/or second delay values.

In additional or alternative examples, the information may be derived based on the first delay values and/or the second delay values indicates to the source node for how long the CHO resources are going to be reserved.

In additional or alternative embodiments, the second network node transmits a HANDOVER REQUEST ACKNOWLEDGE from a target candidate gNodeB.

In additional or alternative embodiments, the second network node transmits to the UE the information derived based on the first delay values and/or the second delay and/or the third delay values. In some examples, the information is transmitted within the RRC Reconfiguration message that is to be stored by the UE. In additional or alternative examples, the information is transmitted in the HANDOVER REQUEST ACKNOWLEDGE. In additional or alternative examples, the conditional reconfiguration contains a validity timer value. In additional or alternative examples, the validity timer value is configured per target candidate cell and is set by each target candidate node. In additional or alternative examples, the validity timer value is configured per target candidate node and is set by each target candidate node. In additional or alternative examples, the validity timer value is configured per target candidate cell and is set by the source node. In additional or alternative examples, the validity timer value is configured per target candidate node and is set by the source node.

In additional or alternative embodiments, the second network node uses information derived based on the second delay values to set a resource reservation timer for itself, i.e., for the candidate target network node. Upon expiry of the timer, CHO resources are released. This timer can be be started upon reception of a HANDOVER REQUEST message with CHO indication, and to be stopped upon the detection of a CHO or HO execution for the UE for which CHO has been configured. In some examples, the second network node detects CHO or HO execution for the UE for which CHO has been configured by the reception of an RRC Reconfiguration Complete from the UE. In additional or alternative examples, the second network node detects CHO or HO execution for the UE for which CHO has been configured by the reception of a HANDOVER CANCEL from the first network node. Upon expiry of the timer CHO resources are released.

In some embodiments, the second network node (e.g., target candidate gNodeB) transmits a message to the first network node (e.g., Source gNodeB) including a time duration value indicating for how much time it is reserving resources for CHO before the UE executes (i.e. after that time the second network node releases the resources). In some examples, the time duration value is included in the HANDOVER REQUEST ACKNOWLEDGE message in response to a CHO request. Based on the received value the first network node could accept or reject and, in case it rejects, it can send a HANDOVER CANCEL message to the target candidate. In additional or alternative examples, the information derived based on the first delay values and/or the second delay values is used as input to the admission control mechanism at the candidate target node. If a time duration value, derived based on the first and/or second delay for a given Source node requesting CHO, is longer than a defined threshold (e.g. configured via OAM), the candidate target node rejects the request from that particular Source Node (e.g. sends an HANDOVER PREPARATION FAILURE message in response). Otherwise, it sends a HANDOVER REQUEST ACKNOWLEDGE with the RRCReconfiguration.

In some embodiments, the second network node (e.g., target candidate gNodeB) maintains, per neighbour node/cell, a time duration value (e.g., calculated based on the first and/or the second delays). The target's admission control function may have a time value threshold (possibly configured by OAM) so that for a given CHO request from a Source node, if the time duration value is greater than a time value threshold the CHO request is rejected, otherwise, the CHO request is accepted.

In some examples, if the CHO request is rejected, the second network node transmits a HANDOVER PREPARATION FAILURE. In additional or alternative examples, a cause value in HANDOVER PREPARATION FAILURE is defined to indicate to the first network node (e.g. source gNodeB) that the reason the CHO request was rejected was due to the fact that the time duration value was higher than a defined threshold. In additional or alternative examples, the message may also include the target candidate acceptance's level so the first network node has the opportunity to trigger a sub-sequent request, but with a time duration value that would be acceptable by the target candidate node.

In some examples, if the CHO request is accepted, the second network node transmits a HANDOVER REQUEST ACKNOWLEDGE. In additional or alternative examples, that value is determined based on information derived from the second delay.

In some embodiments, the UE can use the delay values determined by the second network node similarly to how the UE can use the delay values if they were determined by a first network node.

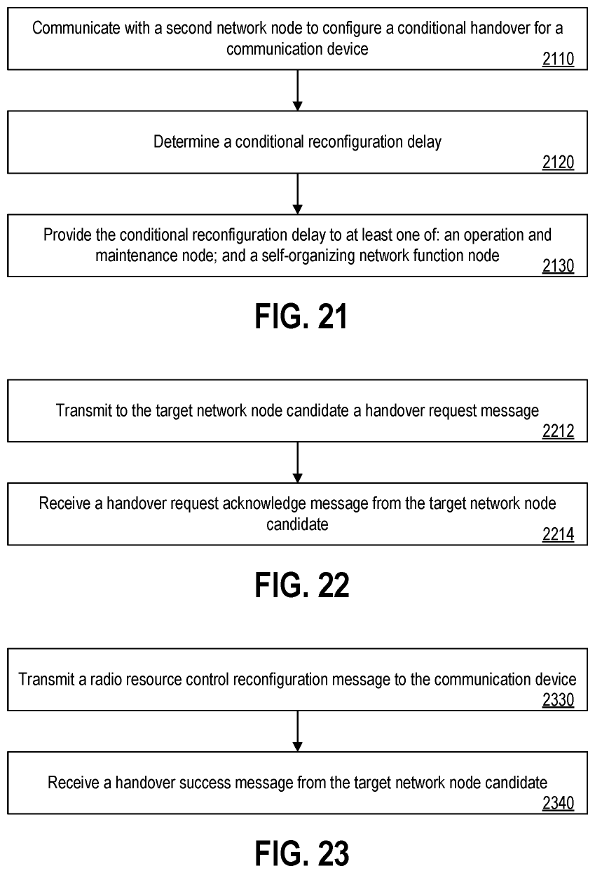

Operations of a network node will now be discussed with reference to the flow charts of FIGS. 21-27 according to some embodiments of inventive concepts. FIGS. 21-27 will be described below as being performed by RAN node 1900 (implemented using the structure of the block diagram of FIG. 19). For example, modules may be stored in memory 1905 of FIG. 19, and these modules may provide instructions so that when the instructions of a module are executed by respective RAN node processing circuitry 1903, processing circuitry 1903 performs respective operations of the flow charts.

FIGS. 21-27 are flow charts illustrating examples of a network node determining a conditional reconfiguration delay during a conditional handover over process in accordance with some embodiments. At block 2110, processing circuitry 1903 communicates with a second network node, via network interface 1907, to configure a conditional handover for a communication device.

FIG. 22 illustrates an example of communicating to configure the conditional handover when the first network node is a source network node and the second network node is a target network node candidate. At block 2212, processing circuitry 1903 transmits to the target network node candidate, via network interface 1907, a handover request message. At block 2214, processing circuitry 1903 receives, via network interface 1907, a handover request acknowledge message from the target network node candidate.

In some embodiments, the conditional reconfiguration delay is a preparation delay associated with a time between the transmission of the HO request message and reception of the HO request acknowledge message. In additional or alternative embodiments, the conditional reconfiguration delay is a CHO validity delay associated with a time duration for which CHO resources in the target network node candidate have been reserved before a CHO execution occurred.

FIG. 23 illustrates an example of additional operations performed by a source network node. At block 2330, processing circuitry 1903 transmits, via network interface 1907, a radio resource control reconfiguration message to the communication device. At block 2340, processing circuitry 1903 receives, via network interface 1907, a handover success message from the target network node candidate.

In some embodiments, determining the CHO validity delay includes measuring an amount of time between receiving the HO request acknowledge message and receiving the HO success message. In additional or alternative embodiments, determining the CHO validity delay includes measuring an amount of time between transmitting the HO request message and receiving the HO success message.

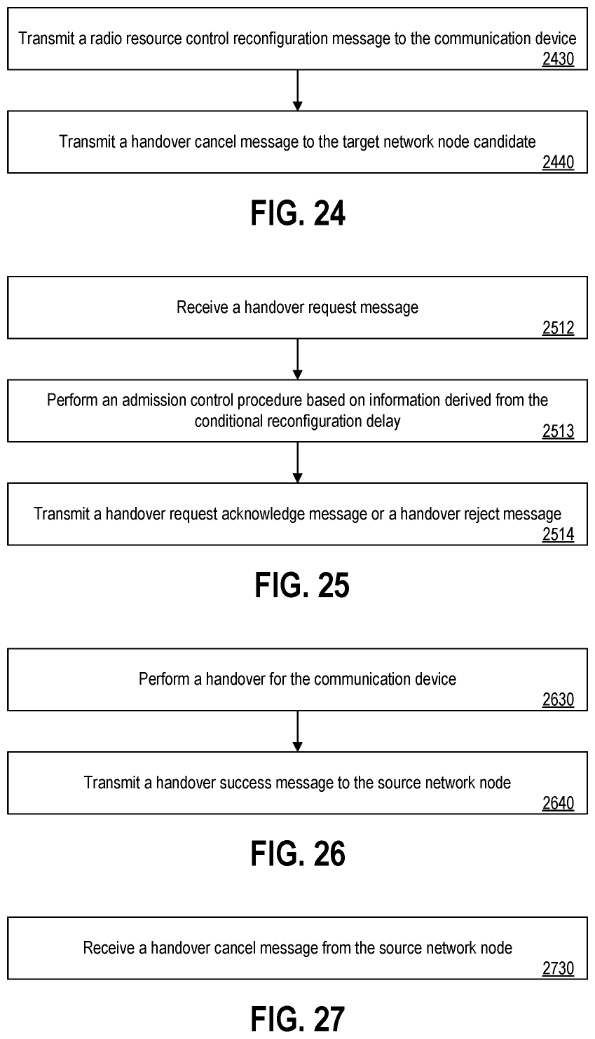

FIG. 24 illustrates an example of additional operations performed by a source network node. At block 2430, processing circuitry 1903 transmits, via network interface 1907, a radio resource control reconfiguration message to the communication device. At block 2440, processing circuitry 1903 transmits, via network interface 1907, a handover cancel message to the target network node candidate.

In some embodiments, determining the CHO validity delay includes measuring an amount of time between transmitting the HO request message and transmitting the HO cancel message. In additional or alternative embodiments, determining the CHO validity delay includes measuring an amount of time between transmitting the HO request message and an internal event of the source network node. In additional or alternative embodiments, determining the conditional reconfiguration delay includes determining a CHO execution delay upon reception of a HO success message.

FIG. 25 illustrates an example of communicating to configure the conditional handover when the first network node is a target network node candidate and the second node is a source network node. At block 2512, processing circuitry 1903 receives, via network interface 1907, a handover request message. At block 2513, processing circuitry 1903 performs an admission control procedure based on information derived from the conditional reconfiguration delay. At block 2514, processing circuitry 1903 transmits, via network interface 1907, a handover request acknowledge message or a handover reject message. In some embodiments, processing circuitry 1903 transmits the handover request acknowledge message or the handover reject message based on results from the admission control procedure.

In some embodiments, the conditional reconfiguration delay is a preparation delay associated with a time between receiving the HO request message and transmitting the HO request acknowledge message. In additional or alternative embodiments, the conditional reconfiguration delay is a CHO validity delay associated with a time duration for which CHO resources in the target network node candidate have been reserved before a CHO execution occurred.

FIG. 26 illustrates an example of additional operations performed by a target network node candidate. At block 2630, processing circuitry 1903 performs a handover for the communication device. At block 2640, processing circuitry 1903 transmits a handover success message to the source network node.

In some embodiments, determining the CHO validity delay includes measuring an amount of time between transmitting the HO request acknowledge message and transmitting the HO success message. In additional or alternative embodiments, determining the CHO validity delay includes measuring an amount of time between receiving the HO request message and transmitting the HO success message.

FIG. 27 illustrates an example of additional operations performed by a target network node candidate. At block 2730, processing circuitry 1903 receives, via network interface 1907, a handover cancel message from the source network node. In some embodiments, determining the CHO validity delay includes measuring an amount of time between receiving the HO request message and receiving the HO cancel message. In additional or alternative embodiments, determining the CHO validity delay comprises measuring an amount of time between transmitting the HO request acknowledge message and receiving the HO cancel message.

Returning to FIG. 21, at block 2120, processing circuitry 1903 determines a conditional reconfiguration delay. In some embodiments, determining the conditional reconfiguration delay includes determining a time between receiving a preamble transmission attempt from the communication device and receiving a RRC reconfiguration complete message from the communication device.

At block 2130, processing circuitry 1903 provides the conditional reconfiguration delay to at least one of: an operation and maintenance, OAM, node; and a self-organizing network, SON, function node. The OAM node can use the information to improve the use of network resources.

Various operations of FIGS. 21-27 may be optional with respect to some embodiments of network nodes and related methods.

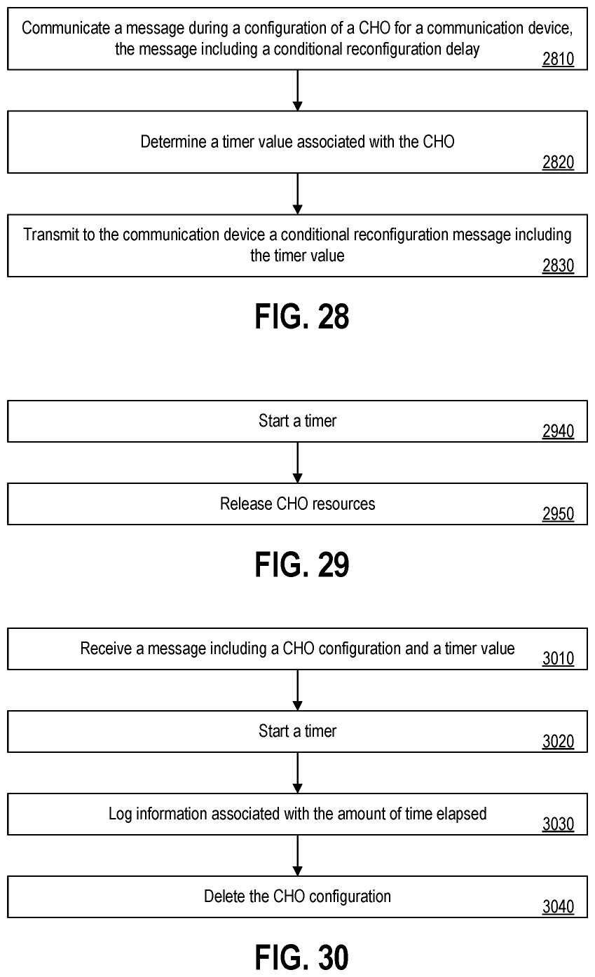

Operations of a network node will now be discussed with reference to the flow charts of FIGS. 28-29 according to some embodiments of inventive concepts. FIGS. 28-29 will be described below as being performed by RAN node 1900 (implemented using the structure of the block diagram of FIG. 19). For example, modules may be stored in memory 1905 of FIG. 19, and these modules may provide instructions so that when the instructions of a module are executed by respective RAN node processing circuitry 1903, processing circuitry 1903 performs respective operations of the flow charts.

FIGS. 28-29 are flow charts illustrating examples of a network node using a conditional reconfiguration delay during a conditional handover over process in accordance with some embodiments.

At block 2810, processing circuitry 1903 communicates, via network interface 1907, a message during a configuration of a CHO for a communication device. In some embodiments, the message includes a conditional reconfiguration delay.

At block 2820, processing circuitry 1903 determines a timer value associated with the CHO.

At block 2830, processing circuitry 1903 transmits, via network interface 1907, to the communication device a conditional reconfiguration message including the timer value.

In some embodiments, the first network node is a source network node and the second network node is a target network node candidate. Communicating the message with the second network node can include transmitting a HO request message to the target network node candidate. The HO request message can include the information associated with the conditional reconfiguration delay. Determining the timer value associated with the CHO can include receiving a HO request acknowledge message from the target network node candidate. The HO request acknowledge message can include the timer value.

In additional or alternative embodiments, the first network node is a target network node candidate and the second network node is a source network node. Communicating the message with the second network node can include receiving a HO request message from the source network node. The HO request message can include the information associated with the conditional reconfiguration delay. Determining the timer value associated with the conditional reconfiguration delay can include determining the timer value based on the information associated with the conditional reconfiguration delay.

In some embodiments, the conditional reconfiguration delay includes at least one of a CHO preparation delay, a CHO validity delay, and a CHO execution delay. Determining the timer value based on the information associated with the conditional reconfiguration delay can include comparing the information associated with the conditional reconfiguration delay with previous information associated with previous conditional reconfiguration delays.

In some embodiments, the target network node candidate can transmit a HO request acknowledge message from the target network node candidate, the HO request acknowledge message including the timer value.

FIG. 29 illustrates an example of additional operations performed by a target network node candidate. At block 2940, processing circuitry 1903 starts a timer. At block 2950, processing circuitry 1903, in response to the timer exceeding the time value, releases CHO resources.

Various operations of FIGS. 28-29 may be optional with respect to some embodiments of network nodes and related methods.

Operations of a communication device will now be discussed with reference to the flow chart of FIG. 30 according to some embodiments of inventive concepts. FIG. 30 will be described below as being performed by communication device 1800 (implemented using the structure of the block diagram of FIG. 18). For example, modules may be stored in memory 1805 of FIG. 18, and these modules may provide instructions so that when the instructions of a module are executed by respective communication device processing circuitry 1803, processing circuitry 1803 performs respective operations of the flow charts.

FIG. 30 illustrates an example of a communication device using conditional reconfiguration delays during a conditional handover over process in accordance with some embodiments.

At block 3010, processing circuitry 1803 receives, via transceiver 1801, a message including a CHO configuration and a timer value. In some embodiments, the message is received from a source network node. In additional or alternative embodiments, the message is received from a target network node candidate.

At block 3020, processing circuitry 1803 starts a timer. In some embodiments, the timer is started in response to receiving the message. In additional or alternative embodiments, the timer may be stopped in response to CHO execution, HO execution, or a HO failure.

At block 3030, processing circuitry 1803 logs information associated with the amount of time elapsed. In some embodiments, logging the information includes storing the information in a report (e.g., a RLF report, a HOF report, a SCG failure report, and a MCG failure report). In additional or alternative embodiments, the report including the information is transmitted to another network node while the timer is running.

At block 3040, processing circuitry 1803 deletes the CHO configuration. In some embodiments, the CHO configuration is deleted in response to the timer exceeding the timer value.

Various operations of FIG. 30 may be optional with respect to some embodiments of a communication device and related methods.

[symbol]

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method of operating a first network node in a communication network, the method comprising:
communicating with a second network node regarding configuration of a conditional handover, CHO, for a communication device; and
responsive to communicating with the second network node, determining a delay associated with the CHO.

2. The method of claim 1, wherein communicating with the second network node comprises communicating with the second network node to configure the CHO, and
wherein determining the delay comprises determining a conditional reconfiguration delay.

3. The method of claim 2, wherein the first network node is a source network node and the second network node is a target network node candidate.

4. The method of claim 3, wherein communicating with the second network node to configure the CHO comprises:
transmitting to the target network node candidate a handover, HO, request message comprising an indication that the HO request message is associated with a CHO; and
receiving a HO request acknowledge message from the target network node candidate, and
wherein the conditional reconfiguration delay is a preparation delay associated with a time between transmission of the HO request message and reception of the HO request acknowledge message.

5. (canceled)

6. The method of any of claim 4, wherein the conditional reconfiguration delay is a CHO validity delay associated with a time duration for which CHO resources in the target network node candidate have been reserved before a CHO execution occurred.

7. The method of claim 6, further comprising:
transmitting a radio resource control, RRC, reconfiguration message to the communication device, the RRC reconfiguration message comprising CHO configuration; and
responsive to transmitting the RRC reconfiguration message, receiving a HO success message from the target network node candidate
wherein determining the CHO validity delay comprises measuring at least one of:
an amount of time between receiving the HO request acknowledge message and receiving the HO success message; and
an amount of time between transmitting the HO request message and receiving the HO success message.

8-9. (canceled)

10. The method of claim 6, further comprising:
transmitting a radio resource control, RRC, reconfiguration message to the communication device, the RRC reconfiguration message comprising CHO configuration; and
responsive to transmitting the RRC reconfiguration message, transmitting a HO cancel message to the target network node candidate
wherein determining the CHO validity delay comprises measuring an amount of time between transmitting the HO request message and transmitting the HO cancel message.

11. (canceled)

12. The method of any of claim 6, wherein determining the CHO validity delay comprises measuring an amount of time between transmitting the HO request message and an internal event of the source network node; or
wherein determining the conditional reconfiguration delay comprises determining a CHO execution delay upon reception of a HO success message.

13-14. (canceled)

15. The method of claim 4, wherein the first network node is a target network node candidate and the second network node is a source network node,
wherein communicating with the second network node to configure the CHO comprises:
receiving from the source network node a HO request message comprising an indication that the HO request message is associated with a CHO; and
transmitting a HO request acknowledge message to the source network node, and
wherein the conditional reconfiguration delay is a preparation delay associated with a time between receiving the HO request message and transmitting the HO request acknowledge message.

16. (canceled)

17. The method of claim 4, wherein the first network node is a target network node candidate and the second network node is a source network node, and
wherein the conditional reconfiguration delay is a CHO validity delay associated with a time duration for which CHO resources in the target network node candidate have been reserved before a CHO execution occurred,
the method further comprising either:
performing a HO for the communication device and transmitting a HO success message to the source network node, or
receiving a HO cancel message from the source network node,
wherein determining the CHO validity delay comprises measuring at least one of:
an amount of time between transmitting the HO request acknowledge message and transmitting the HO success message; and
an amount of time between receiving the HO request message and transmitting the HO success message.

18-23. (canceled)

24. The method of claim 2, wherein the first network node is a target network node candidate and the second network node is a source network node, and
wherein determining the conditional reconfiguration delay comprises determining a time between receiving a preamble transmission attempt from the communication device and receiving a RRC reconfiguration complete message from the communication device
the method further comprising:
performing an admission control procedure based on information derived from the conditional reconfiguration delay; and
transmitting a HO request acknowledge message or a HO reject message based on a result of the admission control procedure.

25. (canceled)

26. The method of claim 2, further comprising:
providing the conditional reconfiguration delay to at least one of: an operation and maintenance, OAM, node; and a self-organizing network, SON, function node.

27. The method of claim 1, wherein communicating with the second network node comprises communicating a message with the second network node during configuration of the CHO for the communication device, the message comprising information associated with a conditional reconfiguration delay,
wherein determining the delay comprises determining a timer value associated with the CHO,
the method further comprising:
responsive to determining the timer value, transmitting to the communication device a conditional reconfiguration message comprising the timer value,
wherein the first network node is a source network node and the second network node is a target network node candidate,
wherein communicating the message with the second network node comprises transmitting a HO request message to the target network node candidate, the HO request message comprising the information associated with the conditional reconfiguration delay, and
wherein determining the timer value associated with the CHO comprises receiving a HO request acknowledge message from the target network node candidate, the HO request acknowledge message comprising the timer value.

28-31. (canceled)

32. The method of claim 1, wherein communicating with the second network node comprises communicating a message with the second network node during configuration of the CHO for the communication device, the message comprising information associated with a conditional reconfiguration delay,
wherein determining the delay comprises determining a timer value associated with the CHO,
the method further comprising:
responsive to determining the timer value, transmitting to the communication device a conditional reconfiguration message comprising the timer value,
wherein the first network node is a target network node candidate and the second network node is a source network node,
wherein communicating the message with the second network node comprises receiving a HO request message from the source network node, the HO request message comprising the information associated with the conditional reconfiguration delay, and
wherein determining the timer value associated with the conditional reconfiguration delay comprises determining the timer value based on the information associated with the conditional reconfiguration delay,
wherein the conditional reconfiguration delay comprises at least one of a CHO preparation delay, a CHO validity delay, and a CHO execution delay, and wherein determining the timer value based on the information associated with the conditional reconfiguration delay comprises comparing the information associated with the conditional reconfiguration delay with previous information associated with previous conditional reconfiguration delays,
the method further comprising:
transmitting a HO request acknowledge message from the target network node candidate, the HO request acknowledge message comprising the timer value.

33-34. (canceled)

35. The method of claim 1, wherein communicating with the second network node comprises communicating a message with the second network node during configuration of the CHO for the communication device, the message comprising information associated with a conditional reconfiguration delay,
wherein determining the delay comprises determining a timer value associated with the CHO,
the method further comprising:
responsive to determining the timer value, transmitting to the communication device a conditional reconfiguration message comprising the timer value,
wherein the first network node is a target network node candidate and the second network node is a source network node,
the method further comprising either:
responsive to determining the timer value, starting a timer; and
responsive to the timer exceeding the timer value, releasing CHO resources; or
performing an admission control procedure based on information derived from the conditional reconfiguration delay; and
transmitting a HO request acknowledge message or a HO reject message based on a result of the admission control procedure.

36. (canceled)

37. A first network node operating in a first communication network, the first network node comprising:
processing circuitry; and
memory coupled to the processing circuitry and having instructions stored therein that are executable by the processing circuitry to cause the first network node to perform operations comprising:
communicating with a second network node regarding configuration of a conditional handover, CHO, for a communication device; and
responsive to communicating with the second network node, determining a delay associated with the CHO.

38. (canceled)

39. A method of operating a communication device in a communication network, the method comprising:
receiving from a network node a message comprising a conditional handover, CHO, configuration and a timer value;
responsive to receiving the CHO configuration, starting a timer; and
responsive to starting the timer, logging information associated with an amount of time elapsed since starting the timer.

40. The method of claim 39, wherein the network node is a source network node or a target network node candidate,
the method further comprising at least one of:
responsive to the timer exceeding the timer value, deleting the CHO configuration; and
responsive to CHO execution; handover, HO, execution; or a HO failure, stopping the timer.

41-42. (canceled)

43. The method of claim 39, wherein the network node is a source network node or a target network node candidate,
wherein logging the information associated with the amount of time elapsed since starting the timer comprises:
storing the information in a report; and
transmitting the information in the report while the timer is running, and
wherein the report comprises at least one of a RLF report, a HOF report, a SCG failure report, and a MCG failure report.

44. A communication device operating in a first communication network, the communication device comprising:
processing circuitry; and
memory coupled to the processing circuitry and having instructions stored therein that are executable by the processing circuitry to cause the communication device to perform operations comprising:
receiving from a network node a message comprising a conditional handover, CHO, configuration and a timer value;
responsive to receiving the CHO configuration, starting a timer; and
responsive to starting the timer, logging information associated with an amount of time elapsed since starting the timer.

45. (canceled)
